(19) United States
(12) Patent Application Publication
(10) Pub. No.: US 2025/0148677 A1
(43) Pub. Date: May 8, 2025

(54) PROGRAM, IMAGE PROCESSING APPARATUS, AND IMAGE PROCESSING METHOD

(71) Applicant: SONY GROUP CORPORATION, TOKYO (JP)

(72) Inventors: LEO HOSHIKAWA, TOKYO (JP); ATSUSHI IRIE, TOKYO (JP); TAKESHI OHASHI, TOKYO (JP)

(21) Appl. No.: 18/837,241

(22) PCT Filed: Feb. 2, 2023
(86) PCT No.: PCT/JP2023/003344

§ 371 Date: Aug. 9, 2024

(30) Foreign Application Priority Data
Feb. 17, 2022 (JP) 2022-023268

(51) Int. Cl. G06T 13/20; G06T 7/246; G06T 19/20; G06V 10/62; G06V 10/77; G06V 10/82; G06V 20/40; G06V 40/20; G10H 1/00

(52) U.S. Cl. CPC G06T 13/205; G06T 7/251; G06T 19/20; G06V 10/62; G06V 10/7715; G06V 10/82; G06V 20/46; G06V 40/25; G10H 1/0008; G06T 2207/20084; G06T 2207/30196; G06T 2219/2004; G10H 2210/076; G10H 2250/311

(57) ABSTRACT

The present disclosure relates to a program, an image processing apparatus, and an image processing method capable of appropriately synchronizing movements of a plurality of dancers with music in a video in which the plurality of dancers dances. In a video in which a plurality of dancers dances, an action of a main dancer is synchronized with music, and the action of the main dancer synchronized with the music is synchronized with an operation of a sub-dancer, so that an image in which the sub-dancer is synchronized with the action of the main dancer is generated. This can be applied to video editing software.

### TECHNICAL FIELD

The present disclosure relates to a program, an image processing apparatus, and an image processing method, and more particularly, to a program, an image processing apparatus, and an image processing method capable of appropriately synchronizing movements of a plurality of dancers with music in a video in which the plurality of dancers dances.

### BACKGROUND ART

A technology has been proposed in which a movement of a dancer as a teacher and music are encoded on the basis of a video in which the dancer as the teacher dances in accordance with the music, a movement of another dancer is encoded from a video of another dancer who dances in accordance with the same music, and encoded information of both dancers is synthesized to synchronize the movement of another dancer with the movement of the dancer as the teacher (refer to Patent Document 1).

### CITATION LIST

### Patent Document

Patent Document 1: U.S. Pat. No. 10,825,221

### SUMMARY OF THE INVENTION

### Problems to be Solved by the Invention

However, in the technology disclosed in Patent Document 1, since it is assumed that the movement of the dancer as the teacher is correct, in a case where the movement of the dancer as the teacher is not appropriately synchronized with the music, the other dancer is not appropriately synchronized with the music.

Furthermore, in a case where there is a plurality of other dancers, the encoded information cannot be appropriately synthesized, and thus, there is a possibility that the movement of the plurality of other dancers becomes unnatural.

The present disclosure has been made in view of such a situation, and particularly, in a video in which a plurality of dancers dances in accordance with music, movements of the plurality of dancers are appropriately synchronized with the music.

### Solutions to Problems

A program and an image processing apparatus according to an aspect of the present disclosure are a program causing a computer to function as and an image processing apparatus including an image synchronization unit that generates, on the basis of an image in which a first person makes an action in accordance with predetermined music, an image in which a second person different from the first person makes an action in synchronization with the action of the first person.

An image processing method according to another aspect of the present disclosure is an image processing method including generating, on the basis of an image in which a first person makes an action in accordance with predetermined music, an image in which a second person different from the first person makes an action in synchronization with the action of the first person.

In the aspect of the present disclosure, on the basis of the image in which the first person makes an action in accordance with the predetermined music, an image in which the second person different from the first person makes an action in synchronization with the action of the first person is generated.

### BRIEF DESCRIPTION OF DRAWINGS

FIG. 1 is a diagram illustrating an image obtained by imaging a state in which a plurality of dancers dances.

FIG. 2 is a diagram illustrating an outline of the present disclosure.

FIG. 3 is a diagram illustrating a configuration example of a first embodiment of an image processing apparatus of the present disclosure.

FIG. 4 is a diagram illustrating a feature amount used in gait authentication.

FIG. 5 is a diagram illustrating VAE.

FIG. 6 is a diagram illustrating an example of a music feature amount.

FIG. 7 is a diagram illustrating another example of the music feature amount.

FIG. 8 is a diagram illustrating a processing example of a feature amount synthesis unit.

FIG. 9 is a flowchart illustrating image synchronization processing by the image processing apparatus of FIG. 3.

FIG. 10 is a flowchart illustrating main dancer video music synchronization processing of FIG. 9.

FIG. 11 is a flowchart illustrating sub-dancer video music synchronization processing of FIG. 9.

FIG. 12 is a diagram illustrating a configuration example of a second embodiment of the image processing apparatus of the present disclosure.

FIG. 13 is a flowchart illustrating image synchronization processing by the image processing apparatus of FIG. 12.

FIG. 14 is a flowchart illustrating 3D model video music synchronization processing of FIG. 13.

FIG. 15 is a diagram illustrating a configuration example of a third embodiment of the image processing apparatus of the present disclosure.

FIG. 16 is a diagram illustrating a configuration example of a main dancer library generation unit of FIG. 15.

FIG. 17 is a flowchart illustrating main dancer library data generation processing by the main dancer library generation unit of FIG. 16.

FIG. 18 is a flowchart illustrating dance import processing by the image processing apparatus of FIG. 15.

FIG. 19 illustrates a configuration example of a general-purpose computer.

### MODE FOR CARRYING OUT THE INVENTION

Hereinafter, preferred embodiments of the present disclosure will be described in detail with reference to the accompanying drawings. Note that, in the present specification and drawings, components having substantially the same functional configuration are denoted by the same reference signs, and redundant description is omitted.

Hereinafter, modes for carrying out the present technology will be described. Description will be given in the following order.
1. Outline of Present Disclosure
2. First Embodiment
3. Second Embodiment
4. Third Embodiment
5. Example of Execution by Software

### 1. Outline of Present Disclosure

In particular, the present disclosure appropriately synchronizes, in a video in which a plurality of dancers dances in accordance with music, movements of the plurality of dancers with the music.

A technology of imaging a state where a plurality of dancers is dancing in accordance with music, as a video is generally widespread.

In particular, in recent years, there is a service or the like that distributes a video in which a plurality of dancers is dancing in accordance with music, using a short video platform for mobile terminals.

As described above, in capturing a video in which a plurality of dancers is dancing in accordance with music, more sufficient practice is required for the plurality of dancers, and in capturing the video, a plurality of times of imaging may be required until all the dancers can be synchronized with each other.

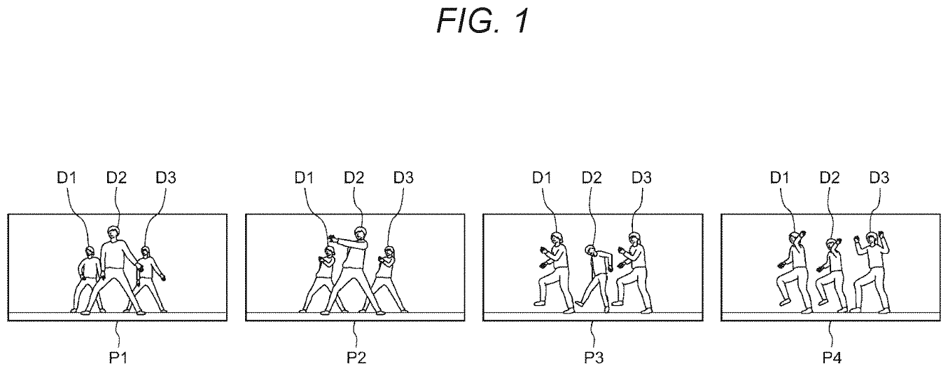

For example, as illustrated in FIG. 1, in a case where three persons including dancers D1 to D3 capture a video while dancing in accordance with music including predetermined music, in an image P1, in a case where it is assumed that the persons are dancers (persons) based on the dancer D1, the dancers D2 and D3 are not synchronized with each other.

Furthermore, in an image P2 of FIG. 1, the dancer D2 is not synchronized with the dancer D1, but the dancer D3 is synchronized with the dancer D1.

Moreover, in an image P3 of FIG. 1, the dancer D2 is not synchronized with the dancer D1, but the dancer D3 is synchronized with the dancer D1.

Furthermore, in an image P4 of FIG. 1, the dancer D2 is synchronized with the dancer D1, but the dancer D3 is not synchronized with the dancer D1.

That is, in a case where the dances of the dancers D1 to D3 are not synchronized with each other as illustrated by the images P1 to P4 of FIG. 1, it is necessary to re-take the dances again or it is necessary to perform further practice, and thus, it takes time and effort to produce the video.

Furthermore, it is necessary not only to simply synchronize the dances of the dancers D1 to D3, but also to appropriately synchronize the dances with the music.

As described above, in order to produce a video in which a plurality of dancers is dancing in accordance with music, it takes various efforts and time such as adjustment of schedules, practice, and imaging of the plurality of dancers.

Therefore, in the present disclosure, in a case where a video in which a plurality of dancers dances in accordance with music is imaged, one of the dancers is set as a reference dancer, a movement of the video of the reference dancer is synchronized with the music, and a movement of the video of the reference dancer synchronized with the music is synchronized with a movement of the video of another dancer, whereby the movements of the plurality of dancers are appropriately synchronized with the music.

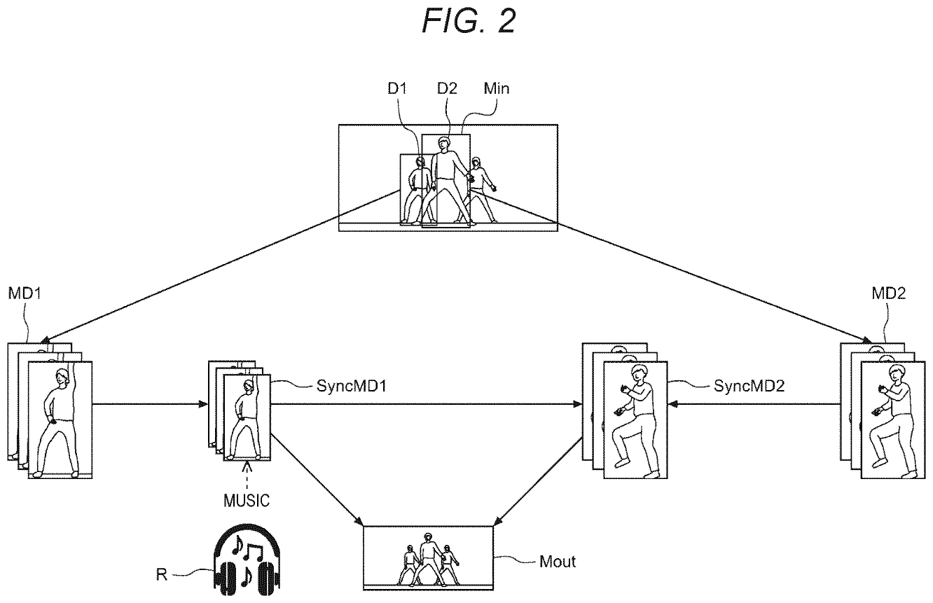

More specifically, as illustrated in FIG. 2, in the case of an input video Min as an imaging result, the background is first excluded from the input video Min, and videos MD1 to MD3 of the dancers D1 to D3 are extracted.

Note that, in FIG. 2, since the video of the dancer D3 is processed in the similar manner as the video of the dancer D2, only the videos MD1 and MD2 of the dancers D1 and D2 will be described.

Next, a video SyncMD1 is generated by synchronizing the video MD1 of the dancer D1 with music R.

Furthermore, by synchronizing the video MD2 of the dancer D2 with the video SyncMD1 of the dancer D1 synchronized with the music R, a video SyncMD2 in which the video MD2 is synchronized with the music R is generated.

Then, the video SyncMD1 and the video SyncMD2 are synthesized to generate a music synchronized synthesis image Mout.

Therefore, the video MD1 of the dancer D1 is synchronized with the music R to generate the video SyncMD1, the video MD2 of the dancer D2 is synchronized with the video SyncMD1 to generate the video SyncMD2 synchronized with the music R, and the videos SyncMD1 and SyncMD2 are synthesized to generate the music synchronized synthesis image Mout including the videos MD1 and MD2 in which the movements of the dancers D1 and D2 are synchronized with the music R.

Note that, in FIG. 2, it is expressed that the video MD3 of the dancer D3 is also processed in the similar manner as the video MD2 to generate the music synchronized synthesis image Mout in which the dancers DI to D3 are synchronized with each other.

As a result, since the videos MD1 to MD3 of the dancers D1 to D3 are synthesized in synchronization with the music R, the videos in which a plurality of dancers dances can be appropriately synthesized with the music.

Note that, in a case where the video MD1 is synchronized with the music R to generate the video SyncMD1, the feature amount extracted from the video MD1 is used, in a case where the video MD2 is synchronized with the music R by being synchronized with the video SyncMD1 to generate the video SyncMD2, the feature amount extracted from the video MD2 and the feature amount extracted from the video MD1 are synthesized and used.

Therefore, the features of the movements of the dancers D1 and D2 can be reflected, the videos SyncMD1 and SyncMD2 can be generated as natural video synchronized with the music R, and by synthesizing the videos SyncMD1 and SyncMD2, the music synchronized synthesis image Mout in which the movements of the plurality of dancers are synchronized with the music can be generated.

As a result, the videos MD1 and MD2 of the dancers D1 and D2 are synthesized in synchronization with the music R, and a video appropriately synchronized with the music can be generated such that the movements of the plurality of dancers do not become unnatural.

### 2. First Embodiment

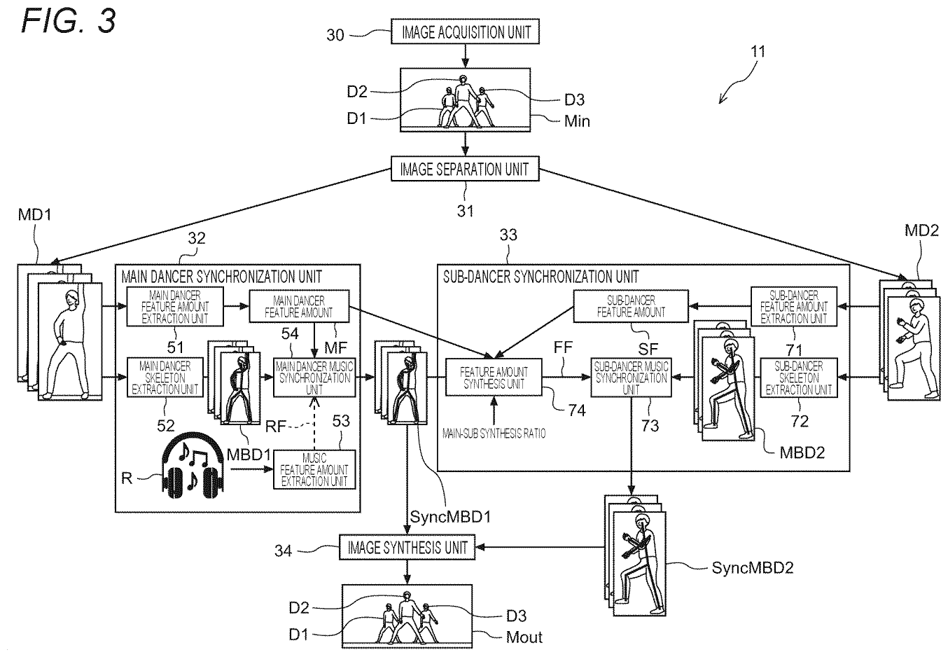

Next, a configuration example of a first embodiment of the image processing apparatus according to the present disclosure will be described with reference to FIG. 3.

An image processing apparatus 11 in FIG. 3 includes an image acquisition unit 30, an image separation unit 31, a main dancer synchronization unit 32, a sub-dancer synchronization unit 33, and an image synthesis unit 34.

Note that the image acquisition unit 30, the image separation unit 31, the main dancer synchronization unit 32, the sub-dancer synchronization unit 33, and the image synthesis unit 34, which are components of the image processing apparatus 11 of FIG. 3, may be configured in a state of being able to communicate with each other on a network.

Furthermore, in that case, each function of the image acquisition unit 30, the image separation unit 31, the main dancer synchronization unit 32, the sub-dancer synchronization unit 33, and the image synthesis unit 34 may be realized by a server computer, a cloud computer, or the like on the network.

The image acquisition unit 30 functions as an imaging unit such as a complementary metal oxide semiconductor (CMOS) image sensor or a charge coupled device (CCD) image sensor, captures the input video Min, and outputs the input video Min to the image separation unit 31. At this time, at the time of imaging, the image acquisition unit 30 acquires audio data of music including the music R that the dancers D1 to D3 are dancing in accordance with, and outputs the audio data of the music R to the image separation unit 31 together with the input video Min.

Furthermore, the image acquisition unit 30 may acquire the input video Min captured by another imaging device or the like and the audio data of the music R via a network, a storage medium, or the like (not illustrated) and output the audio data and the input video Min to the image separation unit 31.

Moreover, here, as illustrated in FIG. 3, it is assumed that the input video Min is a video in which three persons including the dancers D1 to D3 are dancing in accordance with music including a predetermined music R.

Furthermore, it is assumed that, among the dancers D1 to D3, the dancer D1 is a reference dancer, that is, a main dancer, and the dancers D2 and D3 are sub-dancers.

Then, an example will be described in which the movement of the main dancer and the movement of the sub-dancer are synchronized with the music by synchronizing the movement of the main dancer with the music and synchronizing the movement of the sub-dancer with the movement of the main dancer synchronized with the music, and the images of the main dancer and the sub-dancer synchronized with the music are synthesized.

Moreover, among the dancers D2 and D3 as the sub-dancers, the video of the dancer D2 will be described as the video of the sub-dancer, and the description of the video of the dancer D3 will be omitted, but the video of the dancer D3 is also processed in the similar manner as the video of the dancer D2.

The image separation unit 31 removes the background from the input video Min, separates the video of the main dancer and the video of the sub-dancer, outputs the video of the main dancer together with the audio data of the music R to the main dancer synchronization unit 32, and outputs the video of the sub-dancer to the sub-dancer synchronization unit 33.

In this example, the image separation unit 31 extracts the video of the dancer D1, which is the main dancer, from the input video Min as a main dancer video MD1, outputs the main dancer video MD1 together with the audio data of the music R to the main dancer synchronization unit 32, extracts the video of the dancer D2, which is the sub-dancer, as a sub-dancer video MD2, and outputs the sub-dancer video MD2 to the sub-dancer synchronization unit 33.

Furthermore, although not illustrated, the image separation unit 31 outputs the background image removed from the input video Min to the image synthesis unit 34.

The main dancer synchronization unit 32 extracts a main dancer feature amount MF, which is the feature amount of the main dancer D1, from the main dancer video MD1, extracts (estimates) the pose of the main dancer from the video MD1 as main dancer skeleton information MBD1, adjusts the main dancer video MD1 on the basis of the main dancer feature amount MF, and generates a main dancer music synchronized image SyncMBD1 in synchronization with the music R.

Then, the main dancer synchronization unit 32 outputs the generated main dancer feature amount MF and the generated main dancer music synchronized image SyncMBD1 synchronized with the music R to the sub-dancer synchronization unit 33, and outputs the main dancer music synchronized image SyncMBD1 to the image synthesis unit 34.

More specifically, the main dancer synchronization unit 32 includes a main dancer feature amount extraction unit 51, a main dancer skeleton extraction unit 52, a music feature amount extraction unit 53, and a main dancer music synchronization unit 54.

The main dancer feature amount extraction unit 51 includes a convolutional neural network (CNN) or the like, extracts various feature amounts, which can be visually recognized, of the main dancer as the main dancer feature amount MF on the basis of the main dancer video MD1 by learning, and outputs the main dancer feature amount MF to the main dancer music synchronization unit 54 and the sub-dancer synchronization unit 33.

The main dancer feature amount MF is a feature amount obtained from the main dancer video MD1, in other words, a feature amount obtained from an image. More specifically, the main dancer feature amount MF includes information expressing features such as a moving pattern of the main dancer D1 obtained from the main dancer video MD1, and is, for example, a movement speed of a body, a leg, or an arm, a jump height, rising/falling, an estimated weight, a type of facial expression, and a direction and a speed of each of a minute body movement, a head movement, and a foot movement.

### Example of Applying Feature Amount Used for Gait Recognition to Main Dancer Feature Amount

Furthermore, the main dancer feature amount MF may be obtained by applying a feature amount used for gait recognition.

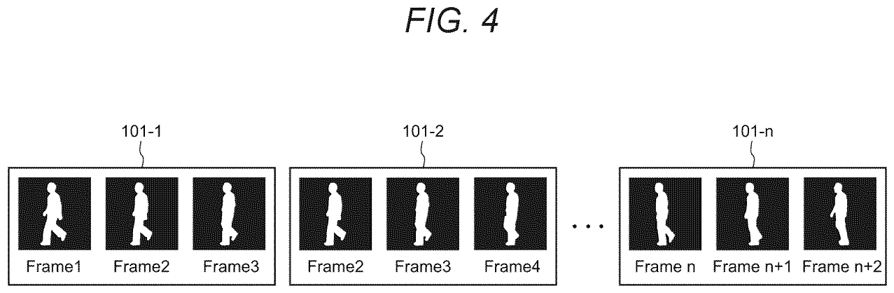

In the gait recognition, as illustrated in FIG. 4, in a case where videos of consecutive frames 1 to (n+2) (Frames 1 to (n+2)) in which silhouettes of a person walking are imaged are used, for example, a silhouette feature amount 101-1 including frames 1 to 3, a silhouette feature amount 101-2 including frames 2 to 4, . . . , a silhouette feature amount 101-n including frames n to (n+2), and the like are used.

That is, an average silhouette feature amount in units of three frames is obtained on the basis of the silhouette feature amounts 101-1 to 101-n, and moreover, the person is individually recognized in combination with a frequency feature amount obtained by frequency analysis of the obtained silhouette feature amount.

Therefore, for the main dancer video MD1 of the main dancer D1, for example, an average silhouette feature amount in units of a predetermined number of frames and a frequency feature amount obtained by the frequency analysis may be used as the main dancer feature amount MF.

### Example of Applying VAE to Main Dancer Feature Amount

Furthermore, a latent variable in variational auto encoders (VAE) may be applied to the main dancer feature amount MF.

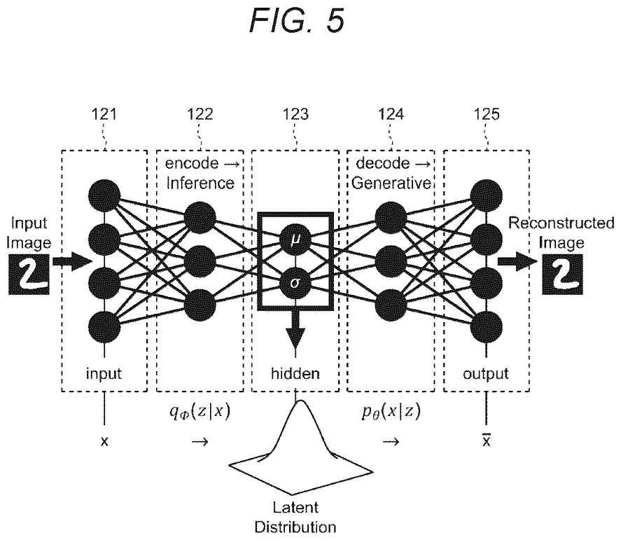

That is, the VAE is a generation model using deep learning, and includes, for example, a neural network including an input layer 121 and an encoder 122, a latent variable (more specifically, a probability distribution including an average value μ representing a latent space in which a latent variable exists and a variance σ) 123 obtained by the input layer 121 and the encoder 122, and a neural network including a decoder 124 and an output layer 125 as illustrated in FIG. 5.

That is, in the VAE, in a case where an image as a recognition target is input to the input layer 121, dimensional compression is performed by the encoder 122, and the latent variable 123 is obtained. Then, the decoder 124 restores the latent variable 123, and the original image is restored and output from the output layer 125.

In the VAE, the latent variable 123 is obtained as a probability distribution including the average value μ representing the latent space and the variance σ, and one latent variable is specified from the latent space by a random number.

Therefore, for the main dancer video MD1 of the main dancer D1, for example, the latent variable 123 may be obtained by the VAE for each image in each frame unit, and may be used as the main dancer feature amount MF.

Here, the description returns to FIG. 3.

The main dancer skeleton extraction unit 52 estimates the main dancer skeleton information MBD1 on the basis of the pose of the main dancer D1 which is, for example, motion capture or the like based on the main dancer video MD1 and is acquired on the basis of the main dancer video MD1, superimposes the main dancer skeleton information MBD1 as an estimation result on the main dancer video MD1, and outputs the resultant to the main dancer music synchronization unit 54.

Note that, in FIG. 3, the main dancer skeleton information MBD1 is expressed by a rod-like line representing a skeleton and a point representing a joint to which an end of the rod-like line representing each skeleton is connected, and a state in which the main dancer skeleton information MBD1 is superimposed on the main dancer video MD1 is expressed.

The music feature amount extraction unit 53 includes, for example, a Recurrent Neural Network (RNN), and extracts a music feature amount RF from music data of the music R of the music to be collected to output the music feature amount RF to the main dancer music synchronization unit 54 in a case where the input video Min is captured.

The music feature amount RF is a feature amount expressing a feature of music based on information of rhythm and lyrics of music.

More specifically, the feature amount based on the information of the music is, for example, information expressing a tempo, and is, for example, a beats per minute (BPM) according to rhythm of a drum, a bass, or the like, a melody of a vocal, a guitar, or the like, of the music.

That is, music is usually a mixture of rhythm and melody, and in a case where a dancer dances in accordance with the music, the movement of the dancer's body corresponds to the rhythm engraved by the drum or the length of each sound constituting the melody.

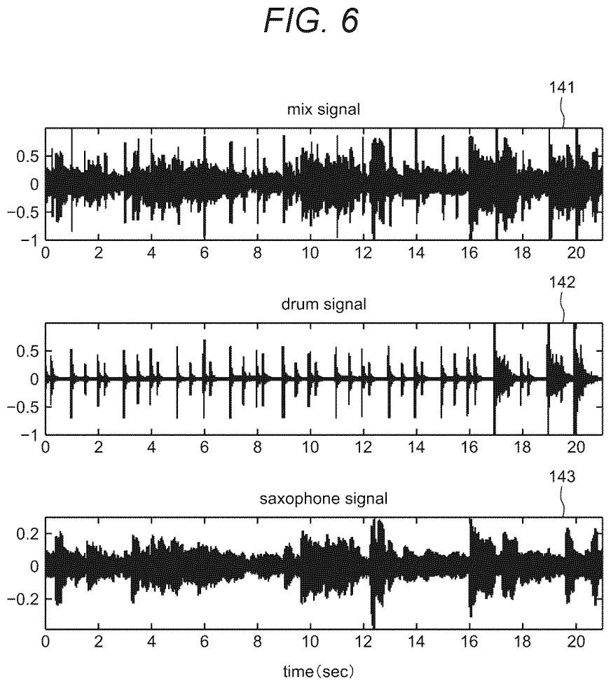

For example, in a case where a music analysis chart 141 of the drum and the saxophone is acquired as illustrated in the upper part of FIG. 6, separation is performed as illustrated in analysis charts 142 and 143 of the drum and the saxophone as illustrated in the middle part and the lower part of FIG. 6.

In this case, the analysis chart 142 of the drum is extracted as the feature amount related to the tempo.

Furthermore, the analysis chart 143 of the saxophone is extracted as the feature amount related to the melody.

Here, for a melody, the speed of the dance is changed depending on the length represented by the note constituting the melody, and in general, the longer the length of the note constituting the melody, the slower the speed of the dance.

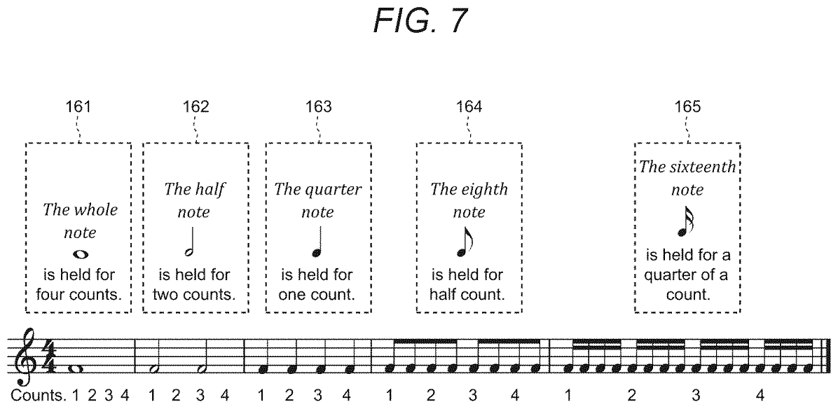

That is, for example, as illustrated in FIG. 7, in a case where a melody is expressed by notes indicating lengths such as the whole note 161, the half note 162, the quarter note 163, the eighth note 164, and the sixteenth note 165 in order from the left in the figure, the longer the length of the sound as expressed by the whole note 161 in the figure, the slower the speed of the dance becomes, and conversely, the shorter the length of the sound as expressed by the sixteenth note 165, the faster the speed of the dance becomes.

Therefore, by setting the length expressed by the note constituting the melody as the music feature amount RF, the feature amount expressing the speed of the dance can be obtained.

Furthermore, the feature amount based on the information of the lyrics is information expressing a tempo according to the meaning of the lyrics. For example, the feature amount expressing a slow tempo is used for emotional expression, and the feature amount expressing a fast tempo is used for active expression or disturbing expression.

The description returns to FIG. 3 again.

The main dancer music synchronization unit 54 includes, for example, a convolutional neural network (CNN), and generates the main dancer music synchronized image SyncMBD1 by synchronizing the main dancer video MD1 on which the main dancer skeleton information MBD1 is superimposed with the music R on the basis of the main dancer feature amount MF and the music feature amount RF by learning, and outputs the main dancer music synchronized image SyncMBD1 to the sub-dancer synchronization unit 33 and the image synthesis unit 34.

More specifically, the main dancer music synchronization unit 54 searches the main dancer video MD1 for a key point which is a timing required for synchronization with the music R.

The key point is, for example, a timing at which the moving pattern of the main dancer D1 is changed. Specifically, the key point is a timing at which the main dancer D1 jumps, a timing at which the main dancer D1 raises and lowers an arm, a timing at which the main dancer D1 changes a moving direction or turns by changing a body direction, or a timing at which the main dancer D1 moves at a speed higher or lower than a predetermined speed or moves.

Then, the main dancer music synchronization unit 54 adjusts the main dancer video MD1 such that the searched key point coincides with a predetermined timing in the music.

In the case of using a simple method, the main dancer music synchronization unit 54 performs adjustment to speed up or down the movement such that the timing as the key point in the main dancer video MD1 coincides with the timing at which predetermined information in the music feature amount RF is changed.

Furthermore, in the case of using a slightly complicated method, the main dancer music synchronization unit 54 simultaneously processes the music R and the main dancer video MD1 using the neural network that analyzes time-series data.

More specifically, the main dancer music synchronization unit 54 may synchronize the main dancer video MD1 on the basis of the music R by using a deep neural network.

Moreover, in the case of synchronizing the main dancer video MD1 with the music R, the main dancer music synchronization unit 54 processes the movement of the dancer D1 in the main dancer video MD1 so as to recognize an error in a predetermined range on the basis of the main dancer feature amount MF, and prioritizes the movement of the dancer D1 over the synchronization with the music R.

That is, since the movement of the dancer D1 may be unnatural by faithfully synchronizing the main dancer video MD1 with the music R, the main dancer music synchronization unit 54 adjusts the main dancer video MD1 to allow the main dancer video MD1 to be slightly out of synchronization with the music R so that the natural movement of the main dancer DI is reproduced when synchronizing the main dancer feature amount MF with the music R.

For example, in a case where the main dancer feature amount MF expressing the movement of the dancer D1 disappears when the main dancer video MD1 is faithfully synchronized with the music R, the main dancer music synchronization unit 54 adjusts and synchronizes the main dancer video MD1 with the music R so as to allow a situation in which the main dancer video MD1 is not synchronized with the music R, which is considered to be an error, to the extent that the main dancer feature amount MF is reproduced.

Alternatively, a parameter for controlling how faithfully the main dancer video MD1 is synchronized with the music R may be set. In this case, the main dancer music synchronization unit 54 adjusts the main dancer video MD1 to be synchronized with the music R according to the parameter.

In other words, according to the parameter, the main dancer music synchronization unit 54 may adjust the main dancer video MD1 to be faithfully synchronized with the music R even in a situation where the main dancer feature amount MF disappears, for example.

Furthermore, according to the parameter, the main dancer music synchronization unit 54 may also perform adjustment by allowing a situation where the main dancer video MD1 is somewhat not synchronized with the music R such that the main dancer feature amount MF completely remains, for example.

Furthermore, according to the parameter, the main dancer music synchronization unit 54 may perform adjustment such that the main dancer video MD1 is synchronized with the music R to the extent that the main dancer feature amount MF remains at a predetermined level, for example.

The sub-dancer synchronization unit 33 extracts a sub-dancer feature amount SF from the sub-dancer video MD2 which is a video of the dancer D2 as the sub-dancer, extracts the pose of the sub-dancer D2 from the sub-dancer video MD2, estimates sub-dancer skeleton information MBD2, superimposes the sub-dancer skeleton information MBD2 on the sub-dancer video MD2, generates a sub-dancer music synchronized image SyncMBD2 by synchronizing the sub-dancer video MD2 with the music R on the basis of the main dancer music synchronized image SyncMBD1, the main dancer feature amount MF, and the sub-dancer feature amount SF, and outputs the sub-dancer music synchronized image SyncMBD2 to the image synthesis unit 34.

More specifically, the sub-dancer synchronization unit 33 includes a sub-dancer feature amount extraction unit 71, a sub-dancer skeleton extraction unit 72, a sub-dancer music synchronization unit 73, and a feature amount synthesis unit 74.

The sub-dancer feature amount extraction unit 71 has a configuration corresponding to the main dancer feature amount extraction unit 51, is configured by a convolutional neural network (CNN) or the like, extracts a feature amount, which can be visually recognized, of the sub-dancer as the sub-dancer feature amount SF on the basis of the sub-dancer video MD2 by learning, and outputs the sub-dancer feature amount SF to the feature amount synthesis unit 74.

The sub-dancer feature amount SF corresponds to the main dancer feature amount MF, includes information expressing a feature such as a moving pattern of the sub-dancer D2, and is, for example, a movement speed of a body, a leg, or an arm, a jump height, rising/falling, an estimated weight, a type of facial expression, and a direction and a speed of each of a minute body movement, a head movement, and a foot movement.

Also, for the sub-dancer feature amount SF, a feature amount used for gait recognition may be applied and used, or a latent variable in variational auto encoders (VAE) may be applied and used.

The sub-dancer skeleton extraction unit 72 has a configuration corresponding to that of the main dancer skeleton extraction unit 52, is, for example, estimates the sub-dancer skeleton information MBD2 on the basis of the pose of the sub-dancer D2 which is, for example, motion capture or the like based on the sub-dancer video MD2 and is acquired on the basis of the sub-dancer video MD2, superimposes the sub-dancer skeleton information MBD2 as the estimation result on the sub-dancer video MD2, and outputs the resultant to the sub-dancer music synchronization unit 73.

Note that, in FIG. 3, the sub-dancer skeleton information MBD2 is expressed by a rod-like line representing a skeleton and a point representing a joint to which an end of the rod-like line representing each skeleton is connected, and a state in which the sub-dancer skeleton information MBD2 is superimposed on the sub-dancer video MD2 is expressed.

The sub-dancer music synchronization unit 73 includes, for example, a convolutional neural network (CNN) and the like, synchronizes the sub-dancer video MD2 on which the sub-dancer skeleton information MBD2 is superimposed with the main dancer music synchronized image SyncMBD1 on which the main dancer skeleton information MBD1 supplied from the feature amount synthesis unit 74 is superimposed, on the basis of a synthesis feature amount FF supplied from the feature amount synthesis unit 74 by learning, generates the sub-dancer music synchronized image SyncMBD2 synchronized with the music R, and outputs the sub-dancer music synchronized image SyncMBD2 to the image synthesis unit 34.

More specifically, the sub-dancer music synchronization unit 73 searches the sub-dancer video MD2 for a key point which is a timing required for synchronization with the music R.

The key point is, for example, a timing at which the moving pattern of the sub-dancer D2 is changed. Specifically, the key point is a timing at which the sub-dancer D2 jumps, a timing at which the sub-dancer D2 raises and lowers an arm, a timing at which the sub-dancer D2 changes a moving direction or turns by changing a body direction, or a timing at which the sub-dancer D2 moves at a speed higher or lower than the speed of the movement or moves.

Then, the sub-dancer music synchronization unit 73 adjusts the sub-dancer video MD2 such that the key point in the searched sub-dancer video MD2 coincides with the key point in the main dancer music synchronized image SyncMBD1 synchronized with the music R.

In the case of using a simple method, the sub-dancer music synchronization unit 73 performs adjustment to speed up or down the movement such that the timing as the key point in the sub-dancer video MD2 coincides with the key point in the main dancer music synchronized image SyncMBD1 synchronized with the music R.

Furthermore, in the case of using a slightly complicated method, the sub-dancer music synchronization unit 73 simultaneously processes the main dancer music synchronized image SyncMBD1 synchronized with the music R and the sub-dancer video MD2 using the neural network that analyzes time-series data.

More specifically, the sub-dancer music synchronization unit 73 may use the deep neural network to synchronize the sub-dancer video MD2 on the basis of the main dancer music synchronized image SyncMBD1 synchronized with the music R.

Moreover, in a case of synchronizing the sub-dancer video MD2 with the main dancer music synchronized image SyncMBD1 synchronized with the music R, the sub-dancer music synchronization unit 73 processes the movement of the dancer D2 in the sub-dancer video MD2 so as to recognize an error in a predetermined range on the basis of the synthesis feature amount FF obtained by synthesizing the main dancer feature amount MF and the sub-dancer feature amount SF on the basis of a main-sub synthesis ratio, and prioritizes the movements of the dancers D1 and D2 over the synchronization with the main dancer music synchronized image SyncMBD1.

That is, since the movement of the dancer D2 may be unnatural by faithfully synchronizing the sub-dancer video MD2 with the main dancer music synchronized image SyncMBD1 synchronized with the music R, the sub-dancer music synchronization unit 73 adjusts the sub-dancer video MD2 to allow the sub-dancer video MD2 to be slightly out of synchronization with the main dancer music synchronized image SyncMBD1 so that the natural movement of the sub-dancer D2 is reproduced when synchronizing the sub-dancer video MD2 with the main dancer music synchronized image SyncMBD1 synchronized with the music R.

For example, in a case where the synthesis feature amount FF including the sub-dancer feature amount SF expressing the movement of the dancer D2 disappears when the sub-dancer video MD2 is faithfully synchronized with the main dancer music synchronized image SyncMBD1, the sub-dancer music synchronization unit 73 adjusts and synchronizes the sub-dancer video MD2 with the main dancer music synchronized image SyncMBD1 so as to allow a situation in which the sub-dancer video MD2 is not synchronized with the main dancer music synchronized image SyncMBD1, which is considered to be an error, to the extent that the synthesis feature amount FF is reproduced.

Alternatively, a parameter for controlling how faithfully the sub-dancer video MD2 is synchronized with the main dancer music synchronized image SyncMBD1 may be set. In this case, the sub-dancer music synchronization unit 73 adjusts the sub-dancer video MD2 to be synchronized with the main dancer music synchronized image SyncMBD1 according to the parameter.

In other words, according to the parameter, the sub-dancer music synchronization unit 73 may adjust the sub-dancer video MD2 to be faithfully synchronized with the main dancer music synchronized image SyncMBD1 even in a situation where the synthesis feature amount FF disappears, for example.

Furthermore, according to the parameter, the sub-dancer music synchronization unit 73 may also perform adjustment by allowing a situation where the sub-dancer video MD2 is somewhat not synchronized with the main dancer music synchronized image SyncMBD1 such that the synthesis feature amount FF completely remains, for example.

Furthermore, according to the parameter, the sub-dancer music synchronization unit 73 may perform adjustment such that the sub-dancer video MD2 is synchronized with the main dancer music synchronized image SyncMBD1 to the extent that the synthesis feature amount FF remains at a predetermined level, for example.

The feature amount synthesis unit 74 acquires the main dancer feature amount MF and the main dancer music synchronized image SyncMBD1 that are supplied from the main dancer synchronization unit 32, and the sub-dancer feature amount SF, synthesizes the main dancer feature amount MF and the sub-dancer feature amount SF on the basis of the main-sub synthesis ratio set in advance, generates the synthesis feature amount FF, and outputs the synthesis feature amount FF together with the main dancer music synchronized image SyncMBD1 to the sub-dancer music synchronization unit 73.

More specifically, the main-sub synthesis ratio is a value that can be set by a user, and may be set in a range of 0 to 100, for example. For example, in the case of main dancer D1:sub-dancer D2=100:0, the feature amount synthesis unit 74 may use the main dancer feature amount MF itself as the synthesis feature amount FF.

Furthermore, in a case where the main-sub synthesis ratio is, for example, main dancer D1:sub-dancer D2=0:100, the feature amount synthesis unit 74 may use the sub-dancer feature amount SF itself as the synthesis feature amount FF.

Moreover, in a case where the main-sub synthesis ratio is, for example, main dancer D1: sub-dancer D2=50:50, the feature amount synthesis unit 74 may synthesize the main dancer feature amount MF and the sub-dancer feature amount SF in a ratio of 50:50 and use the resultant as the synthesis feature amount FF.

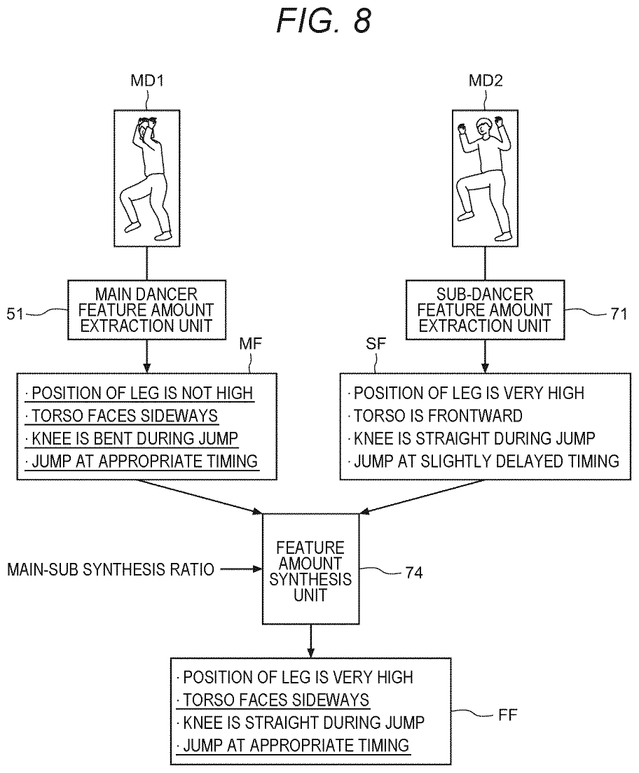

In this case, for example, as illustrated in FIG. 8, a case will be considered in which the main dancer feature amount MF is “the position of the foot is not high”, “the torso faces sideways”, “the knee is bent during the jump”, and “the jump at an appropriate timing”, and the sub-dancer feature amount SF is “the position of the foot is very high”, “the torso is frontward”, “the knee is straight during the jump”, and “the jump at a slightly delayed timing”.

Note that, in FIG. 8, information on each feature amount of the main dancer feature amount MF is underlined.

Here, in a case where the main-sub synthesis ratio is, for example, main dancer D1:sub-dancer D2=50:50, the feature amount synthesis unit 74 synthesizes the main dancer feature amount MF and the sub-dancer feature amount SF by 50% each.

That is, in FIG. 8, the feature amount synthesis unit 74 extracts “the torso faces sideways” and “the jump at an appropriate timing” from the main dancer feature amount MF, extracts “the position of the foot is very high” and “the knee is straight during the jump” from the sub-dancer feature amount SF, and synthesizes the extracted feature amounts to generate the synthesis feature amount FF.

Note that FIG. 8 is an example of the case of main dancer D1:sub-dancer D2=50:50, and other combinations of feature amounts may be used.

Furthermore, which one of the main dancer feature amount MF and the sub-dancer feature amount SF is prioritized for each type of feature amount may be set in advance or may be randomly selected.

Here, the description returns to FIG. 3.

The image synthesis unit 34 acquires the main dancer music synchronized image SyncMBD1, on which the main dancer skeleton information MBD1 is superimposed, supplied from the main dancer synchronization unit 32 and the sub-dancer music synchronized image SyncMBD2 on which the sub-dancer skeleton information MBD2 is superimposed, removes both the main dancer skeleton information MBD1 and the sub-dancer skeleton information MBD2, synthesizes the main dancer music synchronized image SyncMBD1 and the sub-dancer music synchronized image SyncMBD2 with the background image supplied from the image separation unit 31, and outputs the resultant as the music synchronized synthesis image Mout.

That is, with such a configuration, the main dancer synchronization unit 32 synchronizes the main dancer video MD1 with the music R to generate the main dancer music synchronized image SyncMBD1 on which the main dancer skeleton information MBD1 is superimposed, the sub-dancer synchronization unit 33 synchronizes the sub-dancer video MD2 with the main dancer music synchronized image SyncMBD1, which is synchronized with the music R and on which the main dancer skeleton information MBD1 is superimposed, to generate the sub-dancer music synchronized image SyncMBD2 synchronized with the music R, and both the main dancer music synchronized image SyncMBD1 and the sub-dancer music synchronized image SyncMBD2 are synthesized to generate the music synchronized synthesis image Mout.

As a result, in the image obtained by imaging the state in which the plurality of dancers dances in accordance with the music, the video in which the main dancer as a reference dances is synchronized with the music, and the video in which the other sub-dancer dances is synchronized on the basis of the video of the main dancer synchronized with the music, so that the video in which the plurality of dancers dances can be synchronized with the music, and the video in which all the plurality of dancers dances can be synchronized with each other.

### Image Synchronization Processing

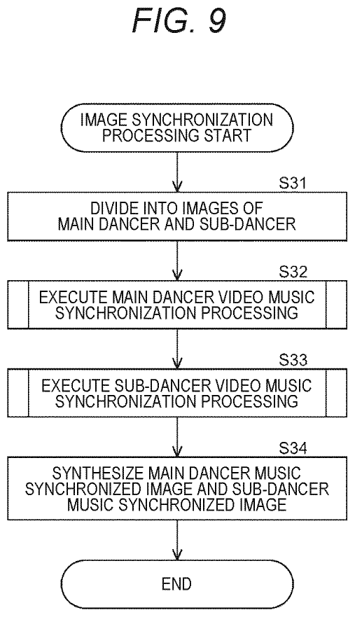

Next, with reference to the flowchart of FIG. 9, image synchronization processing will be described in which, in an image in which a state where a plurality of dancers dances in accordance with music including predetermined music is imaged, a state where the plurality of dancers dances is synchronized with the music.

In step S31, the image acquisition unit 30 images a state in which a plurality of dancers dances in accordance with music including predetermined music, and acquires the captured video as the input video Min or acquires the video captured by another imaging device (not illustrated) as the input video Min. The image acquisition unit 30 outputs the acquired input video Min to the image separation unit 31.

Then, the image separation unit 31 removes the background from the input video Min supplied from the image acquisition unit 30, divides the input video Min into a video MMD of the main dancer and a video MSD of the sub-dancer, respectively outputs the video MMD and the video MSD to the main dancer synchronization unit 32 and the sub-dancer synchronization unit 33, and outputs the background image to the image synthesis unit 34.

In this example, since an example of a case where the input video Min is the input video Min of FIG. 3 will be described, it is assumed that the video of the main dancer D1 is the main dancer video MD1 and the video of the sub-dancer D2 is the sub-dancer video MD2.

In step S32, the main dancer synchronization unit 32 executes main dancer video music synchronization processing to extract the main dancer feature amount MF from the main dancer video MD1.

Furthermore, the main dancer synchronization unit 32 extracts the main dancer skeleton information MBD1 from the main dancer video MD1, superimposes the main dancer skeleton information MBD1 on the main dancer video MD1, synchronizes the main dancer video MD1 with the music R to generate the main dancer music synchronized image SyncMBD1 which is a video of the main dancer D1 and is synchronized with the music R, and outputs the main dancer music synchronized image SyncMBD1 together with the main dancer feature amount MF to the sub-dancer synchronization unit 33.

At this time, the main dancer synchronization unit 32 also outputs the main dancer music synchronized image SyncMBD1, which is a video of the main dancer D1 and is synchronized with the music R, to the image synthesis unit 34.

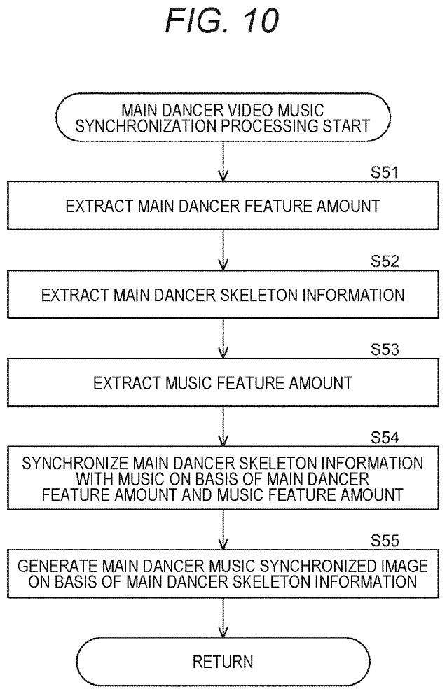

Note that the main dancer video music synchronization processing will be described later in detail with reference to the flowchart of FIG. 10.

In step S33, the sub-dancer synchronization unit 33 executes sub-dancer video music synchronization processing to extract the sub-dancer feature amount SF from the sub-dancer video MD2, to extract the skeleton information MBD2, and to superimpose the skeleton information MBD2 on the sub-dancer video MD2.

Furthermore, the sub-dancer synchronization unit 33 synthesizes the main dancer feature amount MF supplied from the main dancer synchronization unit 32 and the sub-dancer feature amount SF at a predetermined main-sub synthesis ratio to generate the synthesis feature amount FF.

Then, the sub-dancer synchronization unit 33 synchronizes the sub-dancer video MD2 on which the sub-dancer skeleton information MBD2 is superimposed with the main dancer music synchronized image SyncMBD1 on the basis of the synthesis feature amount FF and the main dancer music synchronized image SyncMBD1 to generate the sub-dancer music synchronized image SyncMBD2 synchronized with the music R, and outputs the sub-dancer music synchronized image SyncMBD2 to the image synthesis unit 34.

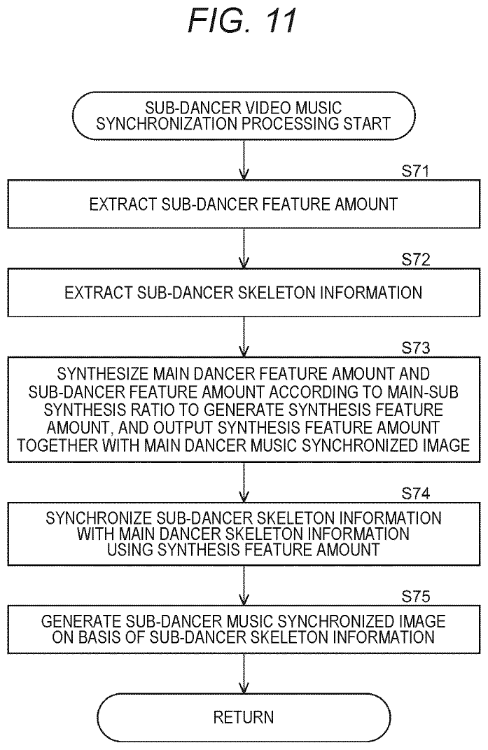

Note that the sub-dancer video music synchronization processing will be described later in detail with reference to the flowchart of FIG. 11.

In step S34, in a case where the image synthesis unit 34 acquires the main dancer music synchronized image SyncMBD1 supplied from the main dancer synchronization unit 32 and the sub-dancer music synchronized image SyncMBD2 supplied from the sub-dancer synchronization unit 33, the image synthesis unit 34 removes the main dancer skeleton information MBD1 and the sub-dancer skeleton information MBD2 from both pieces of the information, and synthesizes the main dancer music synchronized image SyncMBD1 and the sub-dancer music synchronized image SyncMBD2 with the background image of the input video Min to generate and output the music synchronized synthesis image Mout.

By the above processing, in the input video Min obtained by imaging the state where the plurality of dancers dances in accordance with the music including the predetermined music, the video of the main dancer serving as a reference is synchronized with the music to generate the main dancer music synchronized image SyncMBD1, the video MD2 of the sub-dancer is synchronized with the main dancer music synchronized image SyncMBD1 synchronized with the music to generate the sub-dancer music synchronized image SyncMBD2, and thus the video of the sub-dancer is also synchronized with the music.

Then, the main dancer music synchronized image SyncMBD1 and the sub-dancer music synchronized image SyncMBD2 are synthesized to generate and output the music synchronized synthesis image Mout in which the state in which, in the image obtained by imaging the state where the plurality of dancers dances, the plurality of dancers dances is appropriately synchronized with the music including the predetermined music.

As a result, the image obtained by imaging the state where the plurality of dancers dances in accordance with the music including the predetermined music can be set as an image indicating a state where a plurality of dancers dances appropriately synchronously with the music.

### Main Dancer Video Music Synchronization Processing

Next, the main dancer video music synchronization processing by the main dancer synchronization unit 32 will be described with reference to the flowchart of FIG. 10.

In step S51, the main dancer feature amount extraction unit 51 extracts the main dancer feature amount MF from the main dancer video MD1, and outputs the main dancer feature amount MF to the main dancer music synchronization unit 54 and the sub-dancer synchronization unit 33.

In step S52, the main dancer skeleton extraction unit 52 extracts the main dancer skeleton information MBD1 from the main dancer video MD1, and outputs the information superimposed on the image of the main dancer video MD1 to the main dancer music synchronization unit 54.

In step S53, the music feature amount extraction unit 53 extracts the music feature amount RF on the basis of the information on the music R, and outputs the music feature amount RF to the main dancer music synchronization unit 54.

In step S54, the main dancer music synchronization unit 54 synchronizes the main dancer skeleton information MBD1 with the music R on the basis of the main dancer feature amount MF and the music feature amount RF.

In step S55, the main dancer music synchronization unit 54 synchronizes the main dancer video MD1 on the basis of the main dancer skeleton information MBD1 synchronized with the music R to generate the main dancer music synchronized image SyncMBD1, and outputs the main dancer music synchronized image SyncMBD1 to the sub-dancer synchronization unit 33 and the image synthesis unit 34.

By the above processing, the main dancer video MD1 is synchronized with the music R, and is synchronized with the music R in consideration of the main dancer feature amount MF so that the main dancer music synchronized image SyncMBD1 can be generated.

That is, in a case where the main dancer video MD1 is synchronized with the music R, the main dancer feature amount MF is taken into consideration, so that the main dancer skeleton information MBD1 in which the moving pattern of the main dancer D1 is reflected is obtained, and the main dancer music synchronized image SyncMBD1 is generated and synchronized with the music R. Therefore, the video in which the movement of the main dancer D1 is reflected can be obtained, and thus, it is possible to suppress the occurrence of unnatural movements and to perform synchronization with the music R with a more natural video.

### Sub-Dancer Video Music Synchronization Processing

Next, the main dancer video music synchronization processing by the main dancer synchronization unit 32 will be described with reference to the flowchart of FIG. 11.

In step S71, the sub-dancer feature amount extraction unit 71 extracts the sub-dancer feature amount SF from the sub-dancer video MD2, and outputs the sub-dancer feature amount SF to the sub-dancer music synchronization unit 73 and the feature amount synthesis unit 74.

In step S72, the sub-dancer skeleton extraction unit 72 extracts the sub-dancer skeleton information MBD2 from the sub-dancer video MD2, and outputs the information superimposed on the image of the sub-dancer video MD2 to the sub-dancer music synchronization unit 73.

In step S73, the feature amount synthesis unit 74 synthesizes the main dancer feature amount MF and the sub-dancer feature amount SF according to the main-sub synthesis ratio input in advance to generate the synthesis feature amount FF, and outputs the resultant together with the main dancer music synchronized image SyncMBD1, on which the main dancer skeleton information MBD1 is superimposed, supplied from the main dancer synchronization unit 32, to the sub-dancer music synchronization unit 73.

In step S74, the sub-dancer music synchronization unit 73 synchronizes the sub-dancer skeleton information MBD2 with the main dancer skeleton information MBD1 on the basis of the synthesis feature amount FF and the main dancer music synchronized image SyncMBD1.

In step S75, the sub-dancer music synchronization unit 73 synchronizes the sub-dancer skeleton information MBD2 that has been synchronized with the main dancer skeleton information MBD1, with the sub-dancer video MD2 to generate the sub-dancer music synchronized image SyncMBD2, and outputs the sub-dancer music synchronized image SyncMBD2 to the image synthesis unit 34.

By the above processing, the sub-dancer video MD2 is synchronized with the sub-dancer skeleton information MBD2 synchronized with the main dancer music synchronized image SyncMBD1 synchronized with the music R so that the sub-dancer music synchronized image SyncMBD2 is generated.

At this time, the main dancer feature amount MF and the sub-dancer feature amount SF are taken into consideration according to the main-sub synthesis ratio, so that the sub-dancer skeleton information MBD2 in which the moving patterns of the main dancer D1 and the sub-dancer D2 are reflected is obtained, and the sub-dancer music synchronized image SyncMBD2 is generated and synchronized with the music R. Therefore, the video in which the movement of the sub-dancer D2 is reflected can be obtained, and thus, it is possible to suppress the occurrence of unnatural movements and to perform synchronization with the music R with a more natural video.

Furthermore, the synthesis feature amount FF can be generated by synthesizing the main dancer feature amount MF and the sub-dancer feature amount SF according to the main-sub synthesis ratio, to be reflected in the generation of the sub-dancer music synchronized image SyncMBD2. Therefore, the reference dancer can be made substantially the sub-dancer D2 as necessary.

Moreover, the synthesis feature amount FF can be generated by synthesizing the main dancer feature amount MF and the sub-dancer feature amount SF by changing the main-sub synthesis ratio, to be reflected in the generation of the sub-dancer music synchronized image SyncMBD2. Therefore, the main dancer D1 and the sub-dancer D2 can be synthesized at various ratios to be synchronized with the music.

### 3. Second Embodiment

In the above description, an example has been described in which the movements of the plurality of dancers are synchronized with the music on the basis of the input video obtained by imaging the state where the plurality of dancers is dancing in accordance with the music including the predetermined music in the same image.

However, a person (three-dimensional virtual space object) including a 3D model virtually existing in a three-dimensional virtual space may be set as a sub-dancer, and an image in which a person (sub-dancer including a virtual object) including a 3D model dances in synchronization with the main dancer on the real space may be generated on the basis of the image in which the main dancer on the real space is dancing in accordance with the music including the predetermined music.

Since the person (three-dimensional virtual space object) including the 3D model is a virtually set object, physical features such as age, gender, and physique are not limited, and can be freely set. Therefore, the person (three-dimensional virtual space object) including the 3D model may be a real animal, a virtual animal, a robot, or the like. However, since the synchronization processing based on the skeleton information of the main dancer existing in the real space is performed, it is desirable that the physical features such as the number of limbs and the arrangement of the head are in a form close to those of a human being.

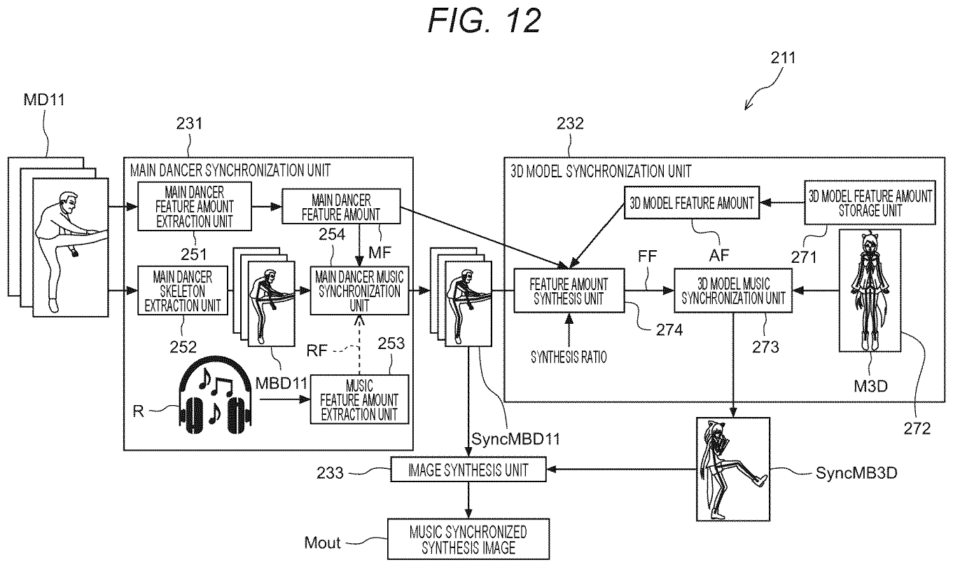

FIG. 12 illustrates a configuration example of a second embodiment of the image processing apparatus configured to generate an image in which a virtually set person (sub-dancer including a virtual object) including a 3D model is dancing in synchronization with a main dancer on a real space, on the basis of an image in which the main dancer on the real space is dancing in accordance with music including predetermined music. An image processing apparatus 211 of FIG. 12 includes a main dancer synchronization unit 231 and a 3D model synchronization unit 232.

The main dancer synchronization unit 231 basically has a configuration corresponding to the main dancer synchronization unit 32 in the image processing apparatus 11 of FIG. 3. The main dancer synchronization unit 231 acquires a main dancer video MD11 in which a dancer D11 as the main dancer is dancing in accordance with the predetermined music R, extracts the main dancer feature amount MF from the main dancer video MD11, estimates main dancer skeleton information MBD11 from the pose of the main dancer D11 from the main dancer video MD11, and synchronizes the main dancer video MD11 with the music R on the basis of the main dancer feature amount MF, the main dancer skeleton information MBD11, and the music R to generate a main dancer music synchronized image SyncMBD11.

Then, the main dancer synchronization unit 231 outputs the generated main dancer feature amount MF and the generated main dancer music synchronized image SyncMBD11 synchronized with the music R to the 3D model synchronization unit 232, and outputs the main dancer music synchronized image SyncMBD11 to an image synthesis unit 233.

More specifically, the main dancer synchronization unit 231 includes a main dancer feature amount extraction unit 251, a main dancer skeleton extraction unit 252, a music feature amount extraction unit 253, and a main dancer music synchronization unit 254. Note that the main dancer feature amount extraction unit 251, the main dancer skeleton extraction unit 252, the music feature amount extraction unit 253, and the main dancer music synchronization unit 254 have the same functions as those of the main dancer feature amount extraction unit 51, the main dancer skeleton extraction unit 52, the music feature amount extraction unit 53, and the main dancer music synchronization unit 54 of FIG. 3, respectively, and thus the description thereof will be omitted.

The 3D model synchronization unit 232 stores a 3D model feature amount corresponding to the sub-dancer feature amount SF, a 3D model image M3D, and 3D model skeleton information MB3D which are of the 3D model virtually existing in the three-dimensional virtual space regarded as the sub-dancer, synchronizes the 3D model image M3D with the music R on the basis of the main dancer music synchronized image SyncMBD11, the main dancer feature amount MF, and 3D model feature amount 3DF to generate a 3D model music synchronized image SyncMB3D, and outputs the 3D model music synchronized image SyncMB3D to the image synthesis unit 233.

More specifically, the 3D model synchronization unit 232 includes a 3D model feature amount storage unit 271, a 3D model image storage unit 272, a 3D model music synchronization unit 273, and a feature amount synthesis unit 274.

The 3D model feature amount storage unit 271 stores the feature amount of the 3D model as the 3D model feature amount 3DF, and outputs the feature amount to the feature amount synthesis unit 274.

The 3D model feature amount 3DF corresponds to the main dancer feature amount MF and the sub-dancer feature amount SF, is a moving pattern of the 3D model, is set in the 3D model existing in the virtual space, and thus can be arbitrarily set.

Also, for the 3D model feature amount 3DF, a feature amount used for gait recognition may be applied to obtain the 3D model feature amount 3DF, or a latent variable in the variational auto encoders (VAE) may be applied to the 3D model feature amount 3DF.

The 3D model image storage unit 272 stores in advance the 3D model image M3D on which the 3D model skeleton information MB3D is superimposed, and outputs the 3D model image M3D on which the 3D model skeleton information MB3D is superimposed, to the 3D model music synchronization unit 273. The information obtained by superimposing the 3D model skeleton information MB3D on the 3D model image M3D is information set in the 3D model in the virtual space, which is so-called skeleton information, and thus can be arbitrarily set.

The 3D model music synchronization unit 273 includes, for example, a convolutional neural network (CNN) and the like, synchronizes the 3D model image M3D on which the 3D model skeleton information MB3D is superimposed with the main dancer music synchronized image SyncMBD11 on which the main dancer skeleton information MBD11 supplied from the feature amount synthesis unit 274 is superimposed, on the basis of the synthesis feature amount FF supplied from the feature amount synthesis unit 274 by learning, generates the 3D model music synchronized image SyncMB3D synchronized with the music R, and outputs the 3D model music synchronized image SyncMB3D to the image synthesis unit 233.

The feature amount synthesis unit 274 has a basic function similar to that of the feature amount synthesis unit 74, acquires the main dancer feature amount MF and the main dancer music synchronized image SyncMBD11 that are supplied from the main dancer synchronization unit 231, and the 3D model feature amount 3DF, synthesizes the main dancer feature amount MF and the 3D model feature amount 3DF on the basis of a synthesis ratio set in advance, generates the synthesis feature amount FF, and outputs the synthesis feature amount FF together with the main dancer music synchronized image SyncMBD11 to the 3D model music synchronization unit 273.

Furthermore, the synthesis ratio is similar to the main-sub synthesis ratio in FIG. 3, sets a synthesis ratio of the main dancer feature amount MF and the 3D model feature amount 3DF in a case of generating the synthesis feature amount FF, and can be arbitrarily set.

The image synthesis unit 233 acquires the main dancer music synchronized image SyncMBD11, on which the main dancer skeleton information MBD11 is superimposed, supplied from the main dancer synchronization unit 231 and the 3D model music synchronized image SyncMB3D on which the 3D model skeleton information MB3D is superimposed, removes both the main dancer skeleton information MBD11 and the 3D model skeleton information MB3D, synthesizes the main dancer music synchronized image SyncMBD11 and the 3D model music synchronized image SyncMB3D with the background image, and outputs the resultant as the music synchronized synthesis image Mout.

That is, with such a configuration, the main dancer synchronization unit 32 synchronizes the main dancer video MD11 with the music R to generate the main dancer music synchronized image SyncMBD11 on which the main dancer skeleton information MBD11 is superimposed, the 3D model synchronization unit 232 synchronizes the 3D model image M3D with the skeleton information MBD11 synchronized with the music R to generate the 3D model music synchronized image SyncMB3D synchronized with the music R, and both the main dancer music synchronized image SyncMBD11 and the 3D model music synchronized image SyncMB3D are synthesized to generate the music synchronized synthesis image Mout.

As a result, the video in which the main dancer dances is synchronized with the music on the basis of the image obtained by capturing the state in which the main dancer dances in accordance with the music, and the video in which the 3D model dances is synchronized on the basis of the video of the main dancer synchronized with the music, so that the video in which the main dancer and the 3D model assumed in the three-dimensional virtual space dances in synchronization with the music can be generated.

### Image Synchronization Processing by Image Processing Apparatus of FIG. 12

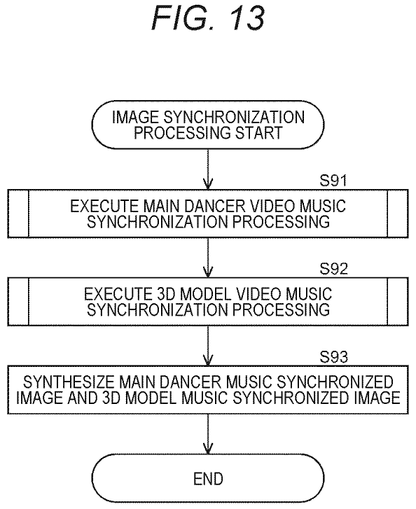

Next, image synchronization processing by the image processing apparatus 211 of FIG. 12 will be described with reference to the flowchart of FIG. 13.

In step S91, the main dancer synchronization unit 231 executes the main dancer video music synchronization processing, and extracts the main dancer feature amount MF from the main dancer video MD11 acquired by, for example, a configuration corresponding to the image acquisition unit 30.

Furthermore, the main dancer synchronization unit 231 extracts the main dancer skeleton information MBD1 from the main dancer video MD11, superimposes the main dancer skeleton information MBD1 on the main dancer video MD11, synchronizes the main dancer video MD11 with the music R to generate the main dancer music synchronized image SyncMBD11 which is a video of the main dancer D11 and is synchronized with the music R, and outputs the main dancer music synchronized image SyncMBD11 together with the main dancer feature amount MF to the 3D model synchronization unit 232.

At this time, the main dancer synchronization unit 231 also outputs the main dancer music synchronized image SyncMBD11, which is a video of the main dancer and is synchronized with the music R, to the image synthesis unit 233.

Note that the main dancer video music synchronization processing is similar to the processing described with reference to the flowchart of FIG. 10, and thus description thereof is omitted.

In step S92, the 3D model synchronization unit 232 executes 3D model video music synchronization processing, reads the 3D model feature amount 3DF stored in advance, reads the 3D model skeleton information MB3D, and superimposes the 3D model skeleton information MB3D on the 3D model image M3D.

Furthermore, the 3D model synchronization unit 232 synthesizes the main dancer feature amount MF supplied from the main dancer synchronization unit 231 and the 3D model feature amount 3DF at a predetermined synthesis ratio to generate the synthesis feature amount FF.

Then, the 3D model synchronization unit 232 synchronizes the 3D model image M3D on which the 3D model skeleton information MB3D is superimposed with the main dancer music synchronized image SyncMBD11 on the basis of the synthesis feature amount FF and the main dancer music synchronized image SyncMBD11 to generate the 3D model music synchronized image SyncMB3D synchronized with the music R, and outputs the 3D model music synchronized image SyncMB3D to the image synthesis unit 233.

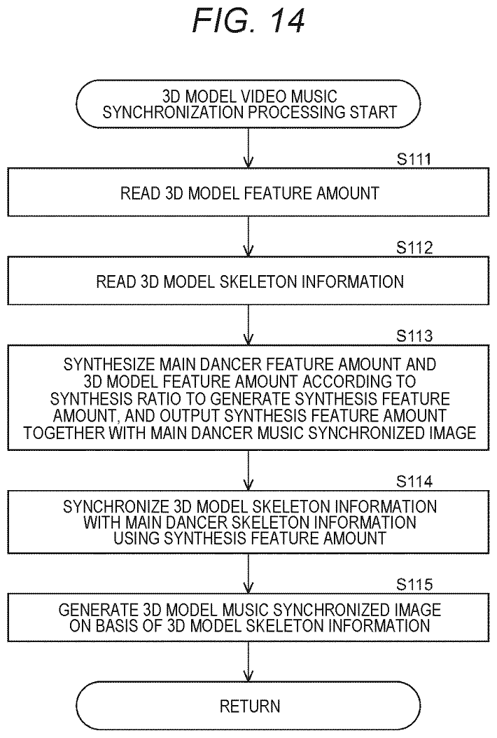

Note that the 3D model video music synchronization processing will be described later in detail with reference to the flowchart of FIG. 14.

In step S93, in a case where the image synthesis unit 233 acquires the main dancer music synchronized image SyncMBD11 supplied from the main dancer synchronization unit 231 and the 3D model music synchronized image SyncMB3D supplied from the 3D model synchronization unit 232, the image synthesis unit 233 removes the main dancer skeleton information MBD11 and the 3D model skeleton information MB3D from both pieces of the information, and synthesizes the main dancer music synchronized image SyncMBD11 and the 3D model music synchronized image SyncMB3D with the background image to generate and output the music synchronized synthesis image Mout.

By the above processing, the video of the main dancer obtained by imaging the state where the main dancer dances in accordance with the music including the predetermined music is synchronized with the music to generate the main dancer music synchronized image SyncMBD11, the 3D model image M3D is synchronized with the main dancer music synchronized image SyncMBD11 synchronized with the music to generate the 3D model music synchronized image SyncMB3D, and thus the 3D model image M3D is also synchronized with the music.

Then, the main dancer music synchronized image SyncMBD11 and the 3D model music synchronized image SyncMB3D are synthesized to generate and output the music synchronized synthesis image Mout in which the state in which the main dancer in the image obtained by imaging the state where the main dancer in the real space dances and the 3D model set in the virtual space dance is appropriately synchronized with the music including the predetermined music.

As a result, an image indicating a state where the main dancer and the 3D model dance appropriately synchronously with the music can be generated on the basis of the image obtained by imaging the state where the main dancer is dancing in accordance with the music including the predetermined music.

### 3D Model Video Music Synchronization Processing

Next, the 3D model video music synchronization processing by the 3D model synchronization unit 232 will be described with reference to the flowchart of FIG. 14.

In step S111, the 3D model feature amount storage unit 271 reads the 3D model feature amount 3DF stored in advance, and outputs the 3D model feature amount 3DF to the feature amount synthesis unit 274.

In step S112, the 3D model image storage unit 272 reads the 3D model image M3D on which the 3D model skeleton information MB3D stored in advance is superimposed, and outputs the 3D model image M3D to the 3D model music synchronization unit 273.

In step S113, the feature amount synthesis unit 274 synthesizes the main dancer feature amount MF and the 3D model feature amount 3DF according to the synthesis ratio input in advance to generate the synthesis feature amount FF, and outputs the resultant together with the main dancer music synchronized image SyncMBD11 supplied from the main dancer synchronization unit 231, to the 3D model music synchronization unit 273.

In step S114, the 3D model music synchronization unit 273 synchronizes the 3D model skeleton information MB3D with the main dancer skeleton information MBD11 on the basis of the 3D model feature amount 3DF, the synthesis feature amount FF, and the main dancer music synchronized image SyncMBD11.

In step S115, the 3D model music synchronization unit 273 synchronizes the 3D model skeleton information MB3D that has been synchronized with the main dancer skeleton information MBD11, with the 3D model image M3D to generate the 3D model music synchronized image SyncMB3D, and outputs the 3D model music synchronized image SyncMB3D to the image synthesis unit 233.

By the above processing, the 3D model image M3D is synchronized with the 3D model skeleton information MB3D synchronized with the main dancer music synchronized image SyncMBD11 synchronized with the music R so that the 3D model music synchronized image SyncMB3D is generated.

At this time, the main dancer feature amount MF and the 3D model feature amount 3DF are taken into consideration according to the synthesis ratio, so that the 3D model skeleton information MB3D in which the moving patterns of the main dancer D11 and the 3D model are reflected is obtained, and the 3D model music synchronized image SyncMB3D is generated and synchronized with the music R. Therefore, the video in which the movement of the 3D model is reflected can be obtained, and thus, it is possible to suppress the occurrence of unnatural movements and to perform synchronization with the music R with a more natural video.

Furthermore, the synthesis feature amount FF can be generated by synthesizing the main dancer feature amount MF and the 3D model feature amount 3DF according to the synthesis ratio, to be reflected in the generation of the 3D model music synchronized image SyncMB3D. Therefore, the reference dancer can be made to be a 3D model as necessary.

Moreover, the synthesis feature amount FF can be generated by synthesizing the main dancer feature amount MF and the 3D model feature amount 3DF by changing the synthesis ratio, to be reflected in the generation of the 3D model music synchronized image SyncMB3D. Therefore, the main dancer D11 and the 3D model can be synthesized at various ratios to be synchronized with the music.

Note that, in the above description, the example of generating the video in which the main dancer and the 3D model are synchronized with the music including the predetermined music by using the feature amounts of the main dancer and the 3D model has been described. However, instead of the 3D model, sub-dancer information including a sub-dancer video and a sub-dancer feature amount of another sub-dancer may be stored in advance, and a video in which the main dancer and the stored sub-dancer dance in synchronization with the music may be generated on the basis of the stored sub-dancer information.

In this case, processing of acquiring the sub-dancer video and the sub-dancer feature amount of the other sub-dancer which are the sub-dancer information is required in advance.

### 4. Third Embodiment

In the above description, the example of generating the video in which one main dancer and the 3D model dance in synchronization with the music including the predetermined music has been described. However, it is also possible to realize a dance import in which an image in which main dancer feature amounts obtained from a plurality of main dancers and main dancer skeleton information can be extracted as library data and the 3D model dances in accordance with arbitrary music can be generated on the basis of the extracted library data.

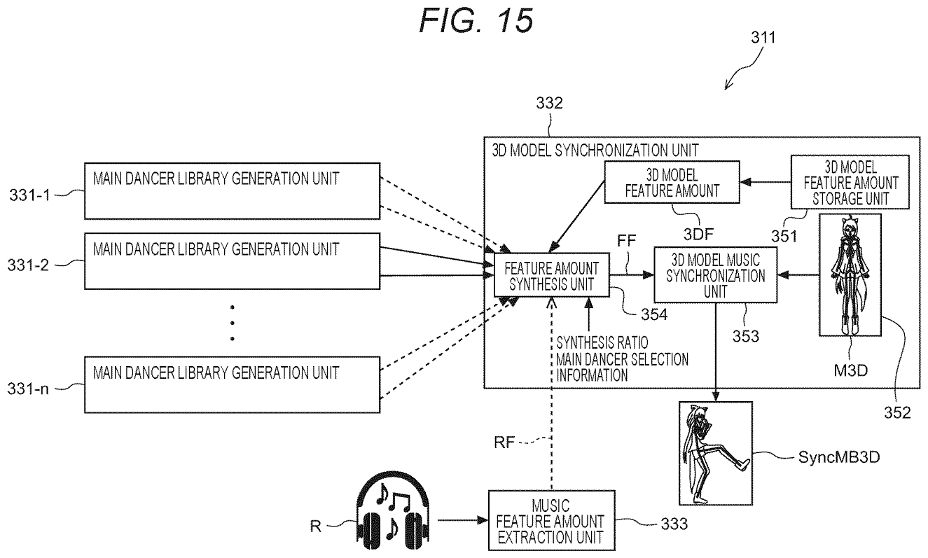

FIG. 15 illustrates a configuration example of the image processing apparatus capable of realizing the dance import in which the main dancer feature amounts obtained from the plurality of main dancer and the main dancer skeleton information can be extracted as the library data and the image in which the 3D model dances in accordance with arbitrary music can be generated on the basis of the extracted library data.

An image processing apparatus 311 of FIG. 15 includes main dancer library generation units 331-1 to 331-n, a 3D model synchronization unit 332, and a music feature amount extraction unit 333.

Note that, hereinafter, in a case where it is not necessary to individually distinguish the main dancer library generation units 331-1 to 331-n, the main dancer library generation units are simply referred to as a main dancer library generation unit 331.

The main dancer library generation unit 331 has a basic configuration corresponding to the main dancer synchronization units 32 and 231, generates library data of the main dancer including the main dancer feature amounts of the plurality of main dancers and the main dancer video on which the main dancer skeleton information is superimposed, and supplies the library data in response to a read request from the 3D model synchronization unit 332.

However, the main dancer library generation unit 331 is different from the main dancer synchronization units 32 and 231 in that the library data of the main dancer including the main dancer feature amount of the main dancer and the main dancer video on which the main dancer skeleton information is superimposed is not synchronized with the music R.

The 3D model synchronization unit 332 has a configuration corresponding to the 3D model synchronization unit 232 of FIG. 12, and has the same basic function, but is different from the 3D model synchronization unit 232 in that a function of synchronizing the main dancer skeleton information of the library data with the music R on the basis of the music feature amount RF supplied from the music feature amount extraction unit 333 is provided.

That is, in the image processing apparatus 311 of FIG. 15, in the main dancer library generation unit 331, the main dancer feature amount and the main dancer video on which the main dancer skeleton information is superimposed are extracted, but are not synchronized with the music R.

Therefore, the 3D model synchronization unit 332 synchronizes the main dancer skeleton information in the extracted library data with the music and further synchronizes the main dancer skeleton information with the 3D model skeleton information on the basis of the music feature amount RF supplied from the music feature amount extraction unit 333. Therefore, it is possible to realize the dance import using the 3D model and the main dancer library data.

Note that the music feature amount extraction unit 333 is similar to the music feature amount extraction units 53 and 253, but can select music that is not used in a case where the main dancer dances when acquiring the library data of the main dancer.

More specifically, the 3D model synchronization unit 332 includes a 3D model feature amount storage unit 351, a 3D model image storage unit 352, a 3D model music synchronization unit 353, and a feature amount synthesis unit 354.

Note that, in the 3D model synchronization unit 332, the 3D model feature amount storage unit 351, the 3D model image storage unit 352, and the 3D model music synchronization unit 353 are similar to the 3D model feature amount storage unit 271, the 3D model image storage unit 272, and the 3D model music synchronization unit 273 of the 3D model synchronization unit 232 of FIG. 12, and thus description thereof is omitted.

That is, the 3D model synchronization unit 332 is different from the 3D model synchronization unit 232 of FIG. 12 in the feature amount synthesis unit 354.

Moreover, the feature amount synthesis unit 354 has a basic function similar to that of the feature amount synthesis unit 274, and moreover, selectively reads the library data from any one of the main dancer library generation units 331-1 to 331-n according to main dancer selection information for specifying which main dancer's library data is to be selected.

Furthermore, the feature amount synthesis unit 354 reads the main dancer feature amount and the main dancer video on which the main dancer skeleton information is superimposed which are included in the library data, acquires the 3D model feature amount supplied from the 3D model feature amount storage unit 351, and synthesizes the main dancer feature amount and the 3D model feature amount on the basis of the synthesis ratio set in advance to generate the synthesis feature amount FF.

Moreover, the feature amount synthesis unit 354 synchronizes the main dancer skeleton information superimposed on the main dancer video included in the library data, on the basis of the music feature amount RF supplied from the music feature amount extraction unit 333, and then outputs the main dancer skeleton information together with the synthesis feature amount to the 3D model music synchronization unit 353.

The 3D model music synchronization unit 353 includes, for example, a convolutional neural network (CNN) and the like, synchronizes the 3D model image M3D on which the 3D model skeleton information MB3D is superimposed with the main dancer skeleton information that is supplied from the feature amount synthesis unit 354 and is synchronized with the music, on the basis of the synthesis feature amount supplied from the feature amount synthesis unit 354 by learning, and generates and outputs the 3D model music synchronized image SyncMB3D synchronized with the music R.

### Configuration Example of Main Dancer Library Generation Unit of FIG. 15

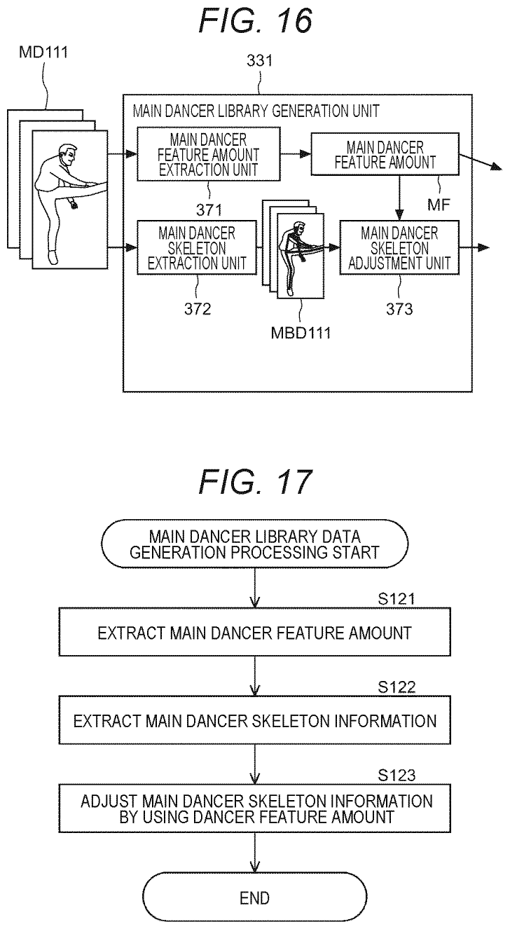

Next, a configuration example of the main dancer library generation unit 331 will be described with reference to FIG. 16.

The main dancer library generation unit 331 includes a main dancer feature amount extraction unit 371, a main dancer skeleton extraction unit 372, and a main dancer skeleton adjustment unit 373.

The main dancer feature amount extraction unit 371 extracts the main dancer feature amount MF on the basis of a main dancer video MD111 of a main dancer D111, outputs the main dancer feature amount MF to the main dancer skeleton adjustment unit 373, and supplies the main dancer feature amount MF to the 3D model synchronization unit 332 in a case where the main dancer library data is requested.

The main dancer skeleton extraction unit 372 is similar to the main dancer skeleton extraction units 52 and 252, extracts main dancer skeleton information MBD111 on the basis of the main dancer video MD111, superimposes the main dancer skeleton information MBD111 on the main dancer video MD111, and outputs the resultant to the main dancer skeleton adjustment unit 373.

The main dancer skeleton adjustment unit 373 includes, for example, a CNN, adjusts the main dancer skeleton information MBD111 superimposed on the main dancer video MD111 supplied from the main dancer skeleton extraction unit 372 by using the main dancer feature amount MF, and supplies the main dancer video MD111 on which the adjusted main dancer skeleton information MBD111 is superimposed to the 3D model synchronization unit 332 in a case where the main dancer library data is requested.

### Main Dancer Library Data Generation Processing

Next, the main dancer library data generation processing in the main dancer library generation unit 331 will be described with reference to the flowchart of FIG. 17.

In step S121, the main dancer feature amount extraction unit 371 extracts the main dancer feature amount MF from the main dancer video MD111 acquired from the image acquisition unit 30 or the like, for example, outputs the main dancer feature amount MF to the main dancer skeleton adjustment unit 373, stores the main dancer feature amount MF, and supplies the main dancer feature amount MF in a case where there is a request from the 3D model synchronization unit 332.

In step S122, the main dancer skeleton extraction unit 372 extracts the main dancer skeleton information MBD111 from the main dancer video MD111, and outputs the information superimposed on the image of the main dancer video MD111 to the main dancer skeleton adjustment unit 373.

In step S123, the main dancer skeleton adjustment unit 373 adjusts the main dancer skeleton information MBD111 by using the main dancer feature amount MF. By this processing, the main dancer skeleton information MBD111 extracted by the main dancer skeleton extraction unit 372 is adjusted in accordance with the moving pattern of the main dancer by using the main dancer feature amount MF, and unnatural movements and the like are suppressed. The main dancer skeleton adjustment unit 373 stores the main dancer video MD111 on which the adjusted main dancer skeleton information MBD111 is superimposed, and supplies the main dancer video MD111 in a case where there is a request from the 3D model synchronization unit 332.

By the above processing, the main dancer feature amount MF is extracted on the basis of the main dancer video MD111, and moreover, the main dancer skeleton information MBD111 can be adjusted in consideration of the main dancer feature amount MF and stored as the library data.

Then, the main dancer feature amount MF and the main dancer video MD111 on which the main dancer skeleton information MBD111 is superimposed are stored as the library data, and can be supplied in a case where there is a request from the 3D model synchronization unit 332.

### Dance Import Processing

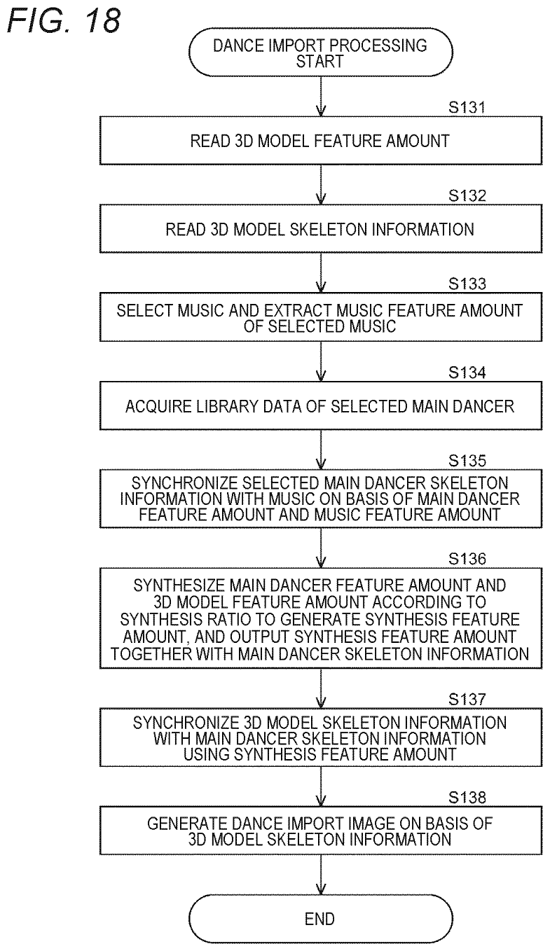

Next, the dance import processing by the 3D model synchronization unit 332 of FIG. 15 will be described with reference to the flowchart of FIG. 18.

In step S131, the 3D model feature amount storage unit 351 reads the 3D model feature amount 3DF stored in advance, and outputs the 3D model feature amount 3DF to the feature amount synthesis unit 354.

In step S132, the 3D model image storage unit 352 outputs the 3D model image M3D on which the 3D model skeleton information MB3D stored in advance is superimposed to the 3D model music synchronization unit 353.

In step S133, the music feature amount extraction unit 333 extracts the music feature amount RF on the basis of the information on the selected music R, and outputs the music feature amount RF to the feature amount synthesis unit 354.

In step S134, the feature amount synthesis unit 354 requests library data of the selected main dancer from the corresponding main dancer library generation unit 331, and acquires the library data.

In step S135, the feature amount synthesis unit 354 reads the main dancer feature amount MF and the main dancer skeleton information MBD111 superimposed on the main dancer video MD111 from the library data of the selected main dancer, and synchronizes the main dancer skeleton information MBD111 with the music R using the main dancer feature amount MF and the music feature amount RF.

In step S136, the feature amount synthesis unit 354 synthesizes the main dancer feature amount MF and the 3D model feature amount 3DF according to the synthesis ratio input in advance to generate the synthesis feature amount FF, and outputs the resultant together with the main dancer skeleton information MBD111 to the 3D model music synchronization unit 353.

In step S137, the 3D model music synchronization unit 353 synchronizes the 3D model skeleton information MB3D with the main dancer skeleton information MBD111 on the basis of the synthesis feature amount FF and the main dancer skeleton information MBD111.

In step S138, the 3D model music synchronization unit 353 synchronizes the 3D model skeleton information MB3D that has been synchronized with the main dancer skeleton information MBD111, with the 3D model image M3D to generate the 3D model music synchronized image SyncMB3D, and outputs the 3D model music synchronized image SyncMB3D as a dance import image.

By the above processing, the main dancer skeleton information MBD111 of the selected library data is synchronized with the selected music R using the main dancer feature amount MF, the 3D model skeleton information MB3D is synchronized on the basis of the main dancer skeleton information MBD111 synchronized with the music, and thereby the 3D model music synchronized image SyncMB3D is generated as the dance import image.

At this time, the main dancer feature amount MF of the selected main dancer and the 3D model feature amount 3DF are taken into consideration according to the synthesis ratio, so that the 3D model skeleton information MB3D in which moving patterns of the main dancer D111 and the 3D model are reflected is obtained, and the 3D model music synchronized image SyncMB3D can be generated as the dance import image on the basis of the 3D model skeleton information MB3D.

### 5. Example of Execution by Software

Incidentally, the series of processing described above can be performed by hardware, but can also be performed by software. In a case where the series of processing is performed by software, a program constituting the software is installed from a recording medium into, for example, a computer built into dedicated hardware or a general-purpose computer capable of performing various functions by installing various programs.

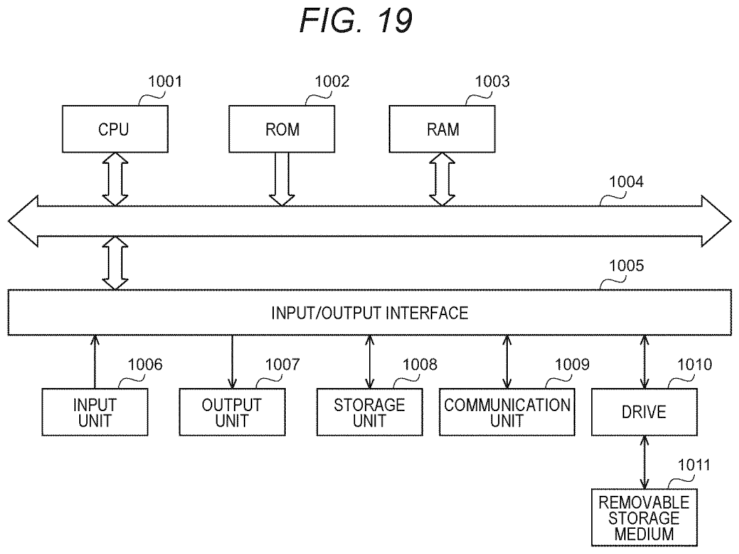

FIG. 19 illustrates a configuration example of a general-purpose computer. This computer includes a central processing unit (CPU) 1001. An input/output interface 1005 is connected to the CPU 1001 via a bus 1004. A read only memory (ROM) 1002 and a random access memory (RAM) 1003 are connected to the bus 1004.

An input unit 1006 including an input device such as a keyboard and a mouse by which the user inputs an operation command, an output unit 1007 that outputs a processing operation screen and an image of a processing result to a display device, a storage unit 1008 that includes a hard disk drive and the like and stores programs and various kinds of data, and a communication unit 1009 including a local area network (LAN) adapter or the like and performs communication processing via a network represented by the Internet are connected to the input/output interface 1005. Furthermore, a drive 1010 that reads and writes data from and to a removable storage medium 1011 such as a magnetic disk (including flexible disk), an optical disc (including compact disc-read only memory (CD-ROM) and digital versatile disc (DVD)), a magneto-optical disk (including mini disc (MD)), or a semiconductor memory is connected.

The CPU 1001 performs various kinds of processing according to a program stored in the ROM 1002 or a program that is read from the removable storage medium 1011 such as a magnetic disk, an optical disc, a magneto-optical disk, or a semiconductor memory, is installed in the storage unit 1008, and is loaded from the storage unit 1008 into the RAM 1003. Furthermore, the RAM 1003 also appropriately stores data required for the CPU 1001 to perform various kinds of processing, and the like.

In the computer configured as described above, for example, the CPU 1001 loads the program stored in the storage unit 1008 into the RAM 1003 via the input/output interface 1005 and the bus 1004, executes the program, and thereby performs the above-described series of processing.

The program executed by the computer (CPU 1001) can be provided by being recorded in the removable storage medium 1011 as a package medium or the like, for example. Furthermore, the program can be provided via a wired or wireless transmission medium such as a local area network, the Internet, or digital satellite broadcasting.

In the computer, the program can be installed in the storage unit 1008 via the input/output interface 1005 by attaching the removable storage medium 1011 to the drive 1010. Furthermore, the program can be received by the communication unit 1009 via a wired or wireless transmission medium and installed in the storage unit 1008. Further, the program can be installed in the ROM 1002 or the storage unit 1008 in advance.

Note that the program executed by the computer may be a program in which processing is performed in time series in the order described in the present specification or may be a program in which processing is performed in parallel or at necessary timing such as when a call is made.

Note that the CPU1001 in FIG. 19 realizes any of the functions of the image separation unit 31, the main dancer synchronization unit 32, the sub-dancer synchronization unit 33, and the image synthesis unit 34 of FIG. 3, the functions of the main dancer synchronization unit 231, the 3D model synchronization unit 232, and the image synthesis unit 233 of FIG. 12, and the functions of the main dancer library generation unit 331, the 3D model synchronization unit 332, and the music feature amount extraction unit 333 of FIG. 15.

Furthermore, in this specification, a system is intended to mean assembly of a plurality of components (devices, modules (parts) and the like) and it does not matter whether or not all the components are in the same housing. Therefore, a plurality of devices that is accommodated in different housings and is connected through the network and one device obtained by accommodating a plurality of modules in one housing are the systems.

Note that, the embodiment of the present disclosure is not limited to the above-described embodiment, and various modifications may be made without departing from the gist of the present disclosure.

For example, the present disclosure may be configured as cloud computing in which one function is shared by a plurality of devices through the network to process together.

Furthermore, each step described in the above-described flowcharts may be executed by one device or executed by a plurality of devices in a shared manner.

Moreover, in a case where a plurality of kinds of processing is included in one step, the plurality of kinds of processing included in the one step may be executed by one device or by a plurality of devices in a shared manner.

Note that the present disclosure may also have the following configurations.
<1> A program causing a computer to function as:
an image synchronization unit that generates, on the basis of an image in which a first person makes an action in accordance with predetermined music, an image in which a second person different from the first person makes an action in synchronization with the action of the first person.
<2> The program according to <1>, causing a computer to further function as:
a music synchronization unit that synchronizes the action of the first person with the music in the image in which the first person makes an action,
in which the image synchronization unit synchronizes the action of the first person synchronized with the music, with the action of the second person to generate an image in which the second person makes an action synchronized with the action of the first person.
<3> The program according to <2>, causing a computer to further function as:
a first skeleton information acquisition unit that acquires first skeleton information expressing a movement of a skeleton of the first person based on an image obtained by imaging the action of the first person;
a music feature amount acquisition unit that acquires a feature amount of the music as a music feature amount; and
a second skeleton information acquisition unit that acquires second skeleton information expressing a movement of a skeleton of the second person based on an image obtained by imaging the action of the second person,
in which the music synchronization unit synchronizes the first skeleton information with the music on the basis of the first skeleton information and the music feature amount to synchronize the action of the first person with the music, and
the image synchronization unit synchronizes the second skeleton information with the first skeleton information that has been synchronized with the music to generate an image in which the second person makes an action in synchronization with the action of the first person.
<4> The program according to <2>,
in which the music synchronization unit and the image synchronization unit include a convolutional neural network (CNN).
<5> The program according to <3>, causing a computer to further function as:
a first feature amount acquisition unit that acquires a feature amount of the first person based on the image in which the first person makes an action, as a first feature amount,
in which the music synchronization unit adjusts a degree of synchronization between the first skeleton information and the music on the basis of the first feature amount.
<6> The program according to <3>,
in which the music synchronization unit searches for a key point of the movement of the first person expressed by the first skeleton information, and synchronizes the first skeleton information with the music on the basis of the searched key point.
<7> The program according to <6>,
in which the key point includes a timing at which a pattern of the movement of the first person expressed by the first skeleton information is changed.
<8> The program according to <7>,
in which the timing at which the pattern of the movement of the first person expressed by the first skeleton information is changed includes a timing at which the movement of the first person jumps, a timing at which the first person raises and lowers an arm, a timing at which the first person changes a moving direction or turns by changing a body direction, or a timing at which the first person moves at a speed higher or lower than a predetermined speed or moves.
<9> The program according to <5>,
in which the image synchronization unit adjusts a degree of synchronization between the second skeleton information and the first skeleton information that has been synchronized with the music, on the basis of the first feature amount.
<10> The program according to <9>, causing a computer to further function as:
a second feature amount acquisition unit that acquires a feature amount of the second person based on the image in which the second person makes an action, as a second feature amount,
in which the image synchronization unit adjusts a degree of synchronization between the second skeleton information and the first skeleton information that has been synchronized with the music, on the basis of the first feature amount and the second feature amount.
<11> The program according to <10>, causing a computer to further function as:
a synthesis unit that synthesizes the first feature amount and the second feature amount at a predetermined synthesis ratio to generate a synthesis feature amount,
in which the image synchronization unit adjusts a degree of synchronization between the second skeleton information and the first skeleton information that has been synchronized with the music, on the basis of the synthesis feature amount.
<12> The program according to <10>,
in which the first feature amount includes information expressing a feature of a moving pattern of the first person and the second feature amount includes information expressing a feature of a moving pattern of the second person.
<13> The program according to <12>,
in which the information expressing the features of the moving patterns of the first person and the second person includes information on a movement speed of a body, a leg, or an arm, a jump height, rising/falling, an estimated weight, a type of facial expression, and a direction and a speed of each of a minute body movement, a head movement, and a foot movement of the first person and the second person, a feature amount used in gait recognition, and is a latent variable of variational auto encoders (VAE).
<14> The program according to any one of <1> to <13>,
in which the actions made by the first person and the second person include actions of dancing in accordance with the music.
<15> The program according to <9>, causing a computer to further function as:
a storage unit that stores the first skeleton information and the first feature amount of a plurality of first persons, as library data,
in which the image synchronization unit adjusts a degree of synchronization between the second skeleton information and the first skeleton information that has been synchronized with the music, on the basis of the library data of any of the plurality of first persons.
<16> The program according to <10>,
in which the second person is an object defined by a three-dimensional model in a three-dimensional virtual space, and
the second feature amount and the second skeleton information are information set on the basis of the three-dimensional model.
<17> The program according to <16>,
in which the second feature amount acquisition unit stores the second feature amount set on the basis of the three-dimensional model, and
the second skeleton information acquisition unit stores the second skeleton information set on the basis of the three-dimensional model in advance.
<18> The program according to <3>,
in which the music feature amount acquisition unit acquires the music feature amount based on a tempo of the music.
<19> The program according to <18>,
in which the music feature amount based on the tempo of the music includes rhythm, melody, and lyrics of the music.
<20> The program according to <19>,
in which the music feature amount based on the rhythm of the music includes a beats per minute (BPM) engraved by a drum or a bass.
<21> The program according to <19>,
in which the music feature amount based on the melody of the music includes a length of a note constituting the melody of the music.
<22> The program according to <19>,
in which the music feature amount based on the lyrics of the music includes a tempo of the music according to meaning of the lyrics.
<23> The program according to <3>,
in which the music feature amount acquisition unit includes a recurrent neural network (RNN).
<24> An image processing apparatus including:
an image synchronization unit that generates, on the basis of an image in which a first person makes an action in accordance with predetermined music, an image in which a second person different from the first person makes an action in synchronization with the action of the first person.
<25> An image processing method including:
generating, on the basis of an image in which a first person makes an action in accordance with predetermined music, an image in which a second person different from the first person makes an action in synchronization with the action of the first person.

### REFERENCE SIGNS LIST

11 Image processing apparatus
30 Image acquisition unit
31 Image separation unit
32 Main dancer synchronization unit
33 Sub-dancer synchronization unit
34 Image synthesis unit
51 Main dancer feature amount extraction unit
52 Main dancer skeleton extraction unit
53 Music feature amount extraction unit
54 Main dancer music synchronization unit
71 Sub-dancer feature amount extraction unit
72 Sub-dancer skeleton extraction unit
73 Sub-dancer music synchronization unit
74 Feature amount synthesis unit
211 Image processing apparatus
231 Main dancer synchronization unit
232 3D model synchronization unit
251 Main dancer feature amount extraction unit
252 Main dancer skeleton extraction unit
253 Music feature amount extraction unit
254 Main dancer music synchronization unit
271 3D model feature amount storage unit
272 3D model image storage unit
273 3D model music synchronization unit
274 Feature amount synthesis unit
311 Image processing apparatus
331 Main model library generation unit
332 3D model synchronization unit
351 3D model feature amount storage unit
352 3D model image storage unit
353 3D model music synchronization unit
354 Feature amount synthesis unit
371 Main dancer feature amount extraction unit
372 Main dancer skeleton extraction unit
373 Main dancer skeleton adjustment unit

1. A program causing a computer to function as:
an image synchronization unit that generates, on a basis of an image in which a first person makes an action in accordance with predetermined music, an image in which a second person different from the first person makes an action in synchronization with the action of the first person.

2. The program according to claim 1, causing a computer to further function as:
a music synchronization unit that synchronizes the action of the first person with the music in the image in which the first person makes an action,
wherein the image synchronization unit synchronizes the action of the first person synchronized with the music, with the action of the second person to generate an image in which the second person makes an action synchronized with the action of the first person.

3. The program according to claim 2, causing a computer to further function as:
a first skeleton information acquisition unit that acquires first skeleton information expressing a movement of a skeleton of the first person based on an image obtained by imaging the action of the first person;
a music feature amount acquisition unit that acquires a feature amount of the music as a music feature amount; and
a second skeleton information acquisition unit that acquires second skeleton information expressing a movement of a skeleton of the second person based on an image obtained by imaging the action of the second person,
wherein the music synchronization unit synchronizes the first skeleton information with the music on a basis of the first skeleton information and the music feature amount to synchronize the action of the first person with the music, and
the image synchronization unit synchronizes the second skeleton information with the first skeleton information that has been synchronized with the music to generate an image in which the second person makes an action in synchronization with the action of the first person.

4. The program according to claim 2,
wherein the music synchronization unit and the image synchronization unit include a convolutional neural network (CNN).

5. The program according to claim 3, causing a computer to further function as:
a first feature amount acquisition unit that acquires a feature amount of the first person based on the image in which the first person makes an action, as a first feature amount,
wherein the music synchronization unit adjusts a degree of synchronization between the first skeleton information and the music based on the first feature amount.

6. The program according to claim 3,
wherein the music synchronization unit searches for a key point of the movement of the first person expressed by the first skeleton information, and synchronizes the first skeleton information with the music on a basis of the searched key point.

7. The program according to claim 6,
wherein the key point includes a timing at which a pattern of the movement of the first person expressed by the first skeleton information is changed.

8. The program according to claim 7,
wherein the timing at which the pattern of the movement of the first person expressed by the first skeleton information is changed includes a timing at which the movement of the first person jumps, a timing at which the first person raises and lowers an arm, a timing at which the first person changes a moving direction or turns by changing a body direction, or a timing at which the first person moves at a speed higher or lower than a predetermined speed or moves.

9. The program according to claim 5,
wherein the image synchronization unit adjusts a degree of synchronization between the second skeleton information and the first skeleton information that has been synchronized with the music, on a basis of the first feature amount.

10. The program according to claim 9, causing a computer to further function as:
a second feature amount acquisition unit that acquires a feature amount of the second person based on the image in which the second person makes an action, as a second feature amount,
wherein the image synchronization unit adjusts a degree of synchronization between the second skeleton information and the first skeleton information that has been synchronized with the music, on a basis of the first feature amount and the second feature amount.

11. The program according to claim 10, causing a computer to further function as:
a synthesis unit that synthesizes the first feature amount and the second feature amount at a predetermined synthesis ratio to generate a synthesis feature amount,
wherein the image synchronization unit adjusts a degree of synchronization between the second skeleton information and the first skeleton information that has been synchronized with the music, on a basis of the synthesis feature amount.

12. The program according to claim 10,
wherein the first feature amount includes information expressing a feature of a moving pattern of the first person and the second feature amount includes information expressing a feature of a moving pattern of the second person.

13. The program according to claim 12,
wherein the information expressing the features of the moving patterns of the first person and the second person includes information on a movement speed of a body, a leg, or an arm, a jump height, rising/falling, an estimated weight, a type of facial expression, and a direction and a speed of each of a minute body movement, a head movement, and a foot movement of the first person and the second person, a feature amount used in gait recognition, and a latent variable of variational auto encoders (VAE).

14. The program according to claim 1,
wherein the actions made by the first person and the second person include actions of dancing in accordance with the music.

15. The program according to claim 9, causing a computer to further function as:
a storage unit that stores the first skeleton information and the first feature amount of a plurality of first persons, as library data,
wherein the image synchronization unit adjusts a degree of synchronization between the second skeleton information and the first skeleton information that has been synchronized with the music, on a basis of the library data of any of the plurality of first persons.

16. The program according to claim 10,
wherein the second person includes an object defined by a three-dimensional model in a three-dimensional virtual space, and
the second feature amount and the second skeleton information include information set on a basis of the three-dimensional model.

17. The program according to claim 16,
wherein the second feature amount acquisition unit stores the second feature amount set on the basis of the three-dimensional model, and
the second skeleton information acquisition unit stores the second skeleton information set on the basis of the three-dimensional model in advance.

18. The program according to claim 3,
wherein the music feature amount acquisition unit acquires the music feature amount based on a tempo of the music.

19. An image processing apparatus comprising:
an image synchronization unit that generates, on a basis of an image in which a first person makes an action in accordance with predetermined music, an image in which a second person different from the first person makes an action in synchronization with the action of the first person.

20. An image processing method comprising:
generating, on a basis of an image in which a first person makes an action in accordance with predetermined music, an image in which a second person different from the first person makes an action in synchronization with the action of the first person.
